(19) United States
(12) Patent Application Publication
(10) Pub. No.: US 2004/0243459 A1
(43) Pub. Date: Dec. 2, 2004

(54) System and method for automating business development

(76) Inventors: William F. Geritz III, Columbia, MD (US); Paul Navarro, Baltimore, MD (US); Patricia Ann Ourednik, Bel Air, MD (US); Donald P. Mahoney, Cochranville, PA (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 10/764,697

(22) Filed: Jan. 26, 2004

Related U.S. Application Data
(60) Provisional application No. 60/442,435, filed on Jan. 24, 2003.

(51) Int. Cl. G06F 17/60

(52) U.S. Cl. 705/10

(57) ABSTRACT

A software enabled business development tool is disclosed to enable subscriber business enterprises to create business development files for individual products and services. A search feature identifies potential partner companies by searching such business development files to evaluate the existence of a potential relationship between business development files warranting investigation of a potential business development transaction, and identifying products and services existing in compatible or complementary market spaces. If a potential partner is identified, a mating engine enables exploration of a variety of business development transactions involving the user's business development file and those of other parties, and solicits enterprise specific input from varying specialized knowledge holders to refine the construction of the deal. The system and method also models the business development transaction, and creates reports in human-readable form describing the transaction.

### CROSS REFERENCE TO RELATED APPLICATION

This application is based upon and claims benefit of copending and co-owned U.S. Provisional Patent Application Serial No. 60/442,435 entitled “System and Method for Automating Business Development”, filed with the U.S. Patent and Trademark Office on Jan. 24, 2003 by the inventors herein, the specification of which is incorporated herein by reference.

### BACKGROUND OF THE INVENTION

1. Field of the Invention

The invention disclosed herein relates generally to a method and system for automating the business process of new product development, and more particularly automating the evaluation of a potential business development transaction represented by combining two or more ideas, products, or services from two or more different business enterprises in the technology market.

2. Background of the Prior Art

Each and every day business organizations, patent holders, inventors, and people with an “idea” look for ways to increase or accelerate revenue for their organizations by finding the “right” market for their product. Sometimes the “right” market may be found in creating a new market or new channel for such product or by integrating complementary technologies with existing technologies. This business process is sometimes referred to as “market creation.”

Several systems have been created to apply computer technology and algorithms to limited segments of business growth enterprises. For example, U.S. Pat. No. 5,765,138 to Aycock et al. discloses an automated supplier evaluation system which provides a potential supplier with a database of project requirements, solicits information from the supplier relating to the supplier's ability to meet the project requirements, and determines a measure of the supplier's sophistication and capabilities in establishing and maintaining quality standards in the design, production, distribution, serviceability, and reliability of the supplier's product or service. Approval of a particular supplier is based on scored supplier responses to questions provided by the firm performing the evaluation.

U.S. Pat. No. 6,295,513 to Thackston discloses an automated method and system for product design and engineering, and for selecting a fabricator to manufacture such product. A network-based computer program enables various persons involved at the engineering stage to develop a product in a computer network environment, and limits access to design data depending on particular users' identification, job function, etc. Once the design is completed, a database of manufacturers may be searched to identify those qualified to manufacture the product based on specified criteria. After a pool of candidate manufacturers has been assembled, an electronic bidding system is used to allow virtual discussions and negotiations to take place over the networked system.

U.S. Pat. No. 6,249,768 to Tulskie, Jr. et al. discloses a framework for analyzing a firm in terms of its resources, capabilities, and strategic positions. The system enables the formulation of computational algorithms to perform analyses and provides a number of “nodes” representing the firm's various resources, capabilities, and strategic positions, while identifying the relationships between such nodes.

U.S. Pat. No. 6,230,066 to Sferro et al. discloses an automated method for carrying out manufacturing and product engineering with knowledge networking to converge on acceptable or improved engineering design functions.

U.S. Pat. No. 6,175,831 to Weinreich et al. discloses a database in which individuals are linked to one another by defined relationships, which the individuals confirm or deny using email messaging and interactive communication between individuals.

U.S. Pat. No. 6,233,493 to Cherneff et al. discloses a computer-implemented product development planning system and method for providing data representing an “optimal” product portfolio. The system has an optimizing engine that operates on an enterprise model having a product model representing products proposed to be manufactured, a component model representing components from which products are made, task models representing tasks to be performed in the development of a component, and resource models representing resources available for use in performing tasks. A constraint engine builds a schedule for the sequence of each product, subject to constraints of the model. The result of this process is a “best” portfolio, that is, one that best satisfies constraints, as well as data representing a pipeline for developing the portfolio.

While these systems disclose various methods of evaluating products and resources of business enterprises, none include a process or system for self-evaluation and to automatically match attributes identified for a searching company with complementary attributes for a potential partner company to evaluate a potential business development transaction between the two. Accordingly, there has been found to remain a need for an automatic business development system that receives input from a business enterprise that is descriptive of such enterprise's products or services, and that is in a standardized format so as to enable automated searching for a match in a complementary business enterprise. Such system should enable the parties to update and modify their inputs in order to predict likely outcomes. Such system should also generate human-readable output describing the structure and financial condition of a business development transaction involving the products and/or services of multiple business enterprises.

### SUMMARY OF THE INVENTION

The present invention comprises a method and system for automating the business process of new product development, and more particularly automating the evaluation of a potential opportunity represented by combining two or more ideas, products, or services. A core “engine” automates the business development process by quantifying and monetizing a business idea, alliance, or joint venture without having detailed market information available. The technology takes conceptual ideas and thoughts, and applies market heuristics and rules of reciprocal product deployment to model a prospective business concept. It uses a pre-built knowledge base of market space definitions and business relationships to model the interdependence of various personalities in typical organizations, such as sales, marketing, engineering, legal, and finance executives. The system evaluates the existence of a potential relationship between users warranting investigation of a potential business development transaction, creates a model of an anticipated business development transaction, and provides various levels of adjustment of the financial construct of the transaction. The method is based on the traits of such selected executives (a financial thinker, a revenue thinker, a sales representative, an engineer, etc.) and applies to deals that do not yet have defined return on investment (ROI), legal protections, trained sales people, or much market understanding.

In accordance with the above and other objects, a software enabled business development tool is disclosed to enable subscriber business enterprises to create business development files for individual products and services. A search feature identifies potential partner companies by searching such business development files for products and services existing in compatible or complementary market spaces. If a potential partner is identified, a mating engine enables exploration of a variety of business development transactions involving the user's business development file and those of other parties, and solicits specific input from varying specialized knowledge holders to refine the construction of the deal. The system and method also models the business development transaction, and creates reports in human-readable form describing the transaction.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a block diagram depicting a first preferred embodiment of an exemplary computer network system according to the instant invention.

FIG. 2 is a flow chart depicting a first preferred embodiment of a method according to the invention.

FIG. 3 is an illustration of a computer display showing an exemplary login screen for accessing the business development server system of FIG. 1.

FIG. 4 is an illustration of a computer display showing an exemplary start page for initiating the functions of the business development server system of FIG. 1.

FIG. 5 is an illustration of a computer display showing an exemplary product description screen generated by the business development server system of FIG. 1.

FIG. 6 is an illustration of a computer display showing an exemplary market description screen generated by the business development server system of FIG. 1.

FIG. 7 is an illustration of a computer display showing an exemplary first sales description screen generated by the business development server system of FIG. 1.

FIG. 8 is an illustration of a computer display showing an exemplary second sales description screen generated by the business development server system of FIG. 1.

FIG. 9 is an illustration of a computer display showing an exemplary business development file list generated by the business development server system of FIG. 1.

FIG. 10 is an illustration of a computer display showing an exemplary business development file record according to a preferred embodiment of the invention.

FIG. 11 is an illustration of a computer display showing an exemplary search screen generated by the business development server system of FIG. 1.

FIG. 12 is an illustration of the search screen of FIG. 11 after a user has selected “target search.”

FIG. 13 is an illustration of a computer display showing an exemplary search status screen generated by the business development server system of FIG. 1.

FIG. 14 is an illustration of a computer display showing an exemplary graphical representation of a market ecosystem generated by the business development server system of FIG. 1.

FIG. 15 is a schematic representation of a portion of the market relationships library database of FIG. 1.

FIG. 16 is an illustration of a computer display showing an exemplary listing of business development files existing within a designated market space.

FIG. 17 is an illustration of a computer display showing an exemplary press article results display screen generated by the business development server system of FIG. 1.

FIG. 18 is an illustration of a computer display showing an exemplary press article selected from the press article results display screen of FIG. 17.

FIG. 19 is an illustration of a computer display showing an exemplary modified market ecosystem of FIG. 14.

FIG. 20 is an illustration of a computer display showing an exemplary deal definition screen generated by the business development server system of FIG. 1.

FIG. 21 is an illustration of a computer display showing an exemplary second deal definition screen generated by the business development server system of FIG. 1.

FIG. 22 is an illustration of a computer display showing an exemplary product description screen generated by the business development server system of FIG. 1.

FIG. 23 is an illustration of a computer display showing an exemplary market definition screen generated by the business development server system of FIG. 1.

FIG. 24 is an illustration of a computer display showing an exemplary sales information screen generated by the business development server system of FIG. 1.

FIG. 25 is an illustration of a computer display showing an exemplary second sales information screen generated by the business development server system of FIG. 1.

FIG. 26 is an illustration of a computer display showing an exemplary model summary and run screen generated by the business development server system of FIG. 1.

FIG. 27 is an illustration of a computer display showing an exemplary model status bar generated by the business development server system of FIG. 1.

FIG. 28 is an illustration of a computer display showing an exemplary executive summary page generated by the business development server system of FIG. 1.

FIG. 29 is an illustration of a computer display showing an exemplary business report summary screen generated by the business development server system of FIG. 1.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. The description of the embodiments set out below are intended to enable one to build and use an implementation of the invention, and are not intended to limit the enumerated claims, but to serve as particular examples thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

An automated business development process is enabled herein to automate each stage of the process and provide a common framework for the intelligent interchange of ideas and markets between and among potential business partners. One purpose of automating such process is to significantly reduce typical business development time by providing quantified business models at an early stage of a relationship. Such process can be utilized to create new markets, accelerate acquisition, and generate increased revenues.

According to a first aspect of the invention, a computer network system enabling the generation of a standardized data file describing a first user's product or service, providing a search mechanism for searching a collection of such standardized data files of other parties to find compatible standardized data files, an automated mating mechanism for mating the user's own standardized data file with the standardized data files of other parties in related markets, and a modeling mechanism for generating a full financial model, business plan, product development rollout schedule, and contract documents pertaining to a business development transaction involving the mated standardized data files is disclosed. The present invention thus provides an apparatus that “normalizes” the business development process, creating a standardized platform that replaces the multiple stages of back-and-forth exploratory discussions traditionally necessary in prior known methods and systems for enabling business development. Users from diverse commercial enterprises may use the system to explore hypothetical business development opportunities with other commercial enterprises without having to actually contact such other commercial enterprises, simply by creating their own standardized data file (i.e., a “business development file”) and storing it on the system, then searching a collection of similarly configured standardized data files of other commercial enterprises on the system to locate those that exist in complementary markets. A library of predetermined relationships between and among particular markets is in communication with or a component of the system, and is accessed during such search, which library may be continuously updated by expert knowledge or by automated search mechanisms. After locating such complementary enterprises, the user may operate the system to mate its standardized data file with one or more standardized data files of other commercial enterprises by inputting to the system the parameters of the anticipated business development transaction between the parties. Once the user has input such data, the user may engage the system to create a full financial model, business plan, product development schedule, and contract documents relating to the business development transaction. In this regard, the system also comprises a knowledge base of business development-related formulas and equations that vary depending upon the data in the user's standardized data file and the data input by the user in describing the business development transaction so as to create a complete business model that accurately reflects the forecasted success of a particular business development transaction.

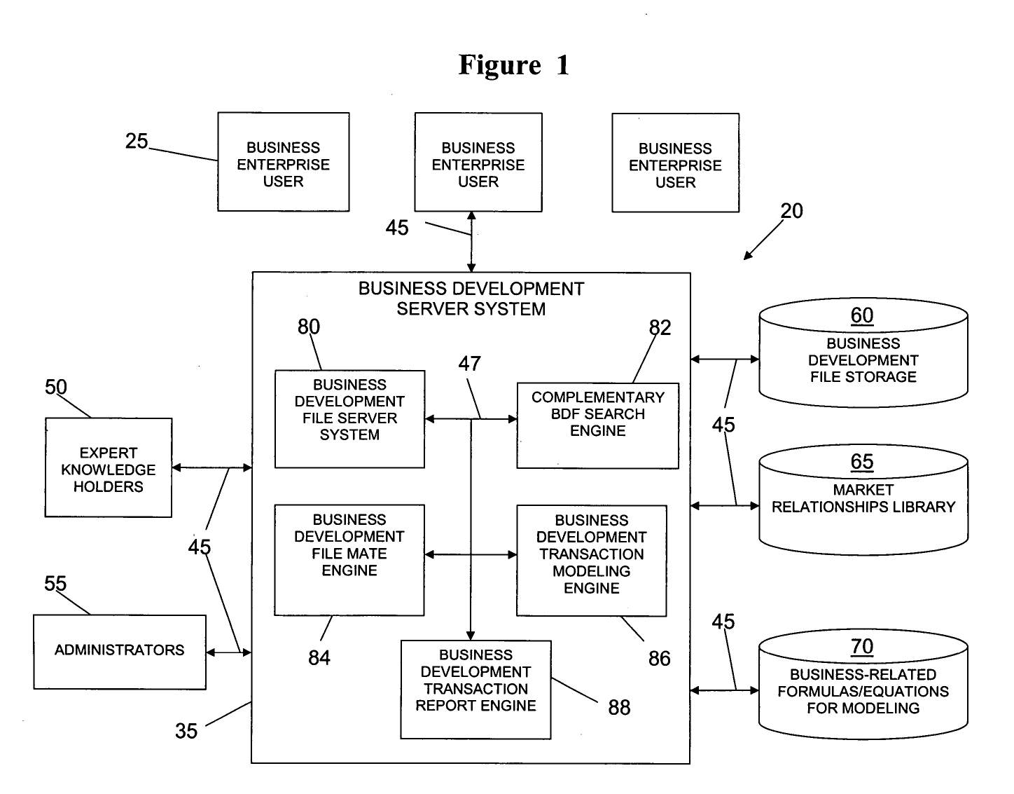

As shown in the schematic view of FIG. 1, a first preferred embodiment of a computer network system (shown generally at 20) of the instant invention provides for virtual collaboration among independent business enterprise users 25 using a business development server system 35 to create descriptions of their own products and services and seek business development transactions relating to some combination of their own products and services with those of other commercial enterprises. The system provides an electronic knowledge base, and mating and modeling functionality that avoids the multi-stage back-and-forth preliminary discussions normally required to accomplish a business development transaction.

The embodiment of computer network system 20 shown in FIG. 1 comprises business development server system 35 which may receive data from and transmit data to a plurality of business enterprise users 25, expert knowledge holders 50, and administrators 55 via a network 45, and which is in communication with one or more data repositories, such as a business development file database 60, a market relationship library database 65, and a business-related formulas/equations for modeling database 70.

Business development server system 35 may comprise a server system supporting the collaborative, interactive business development environment. Business development server system 35 preferably communicates with business enterprise users 25, expert knowledge holders 50, administrators 55, and databases 60, 65, and 70 through network 45. Business development server system 35 preferably is publicly accessible over a network, such as the Internet as a web site, but may provide multiple levels of security to ensure that data associated with a particular commercial enterprise cannot be accessed by other commercial enterprises, and to ensure that unauthorized users cannot access the administrative functions and data. Preferably, business development server system 35 is provided one or more operating systems capable of communicating with databases 60, 65, and 70, enabling operation of the functions of the various software modules of business development server system 35 (described in more detail below), and communicating with business enterprise users 25, expert knowledge holders 50, and administrators 55. The selection of appropriate operating systems for business development server system 35 to accomplish such functionalities is within the knowledge of those of skill in the art.

As shown in FIG. 1, the architecture of business development server system 35 may be distributed, such that hardware and software for the various business development system functions is not necessarily resident on one server system at one physical location. Thus, in the embodiment of FIG. 1, business development server system 35 comprises several interconnected systems for hosting software for various functions, such as business development file server system 80 for creating, editing, and storing business development files; complementary business development file (“BDF”) search engine 82 for searching the stored collection of business development files for ones that are complementary to the user's own business development file; business development file mating engine 84 for providing input describing an anticipated business development transaction involving the user's own business development file and one or more business development files of other commercial enterprise users; business development transaction modeling engine 86 for generating a full financial model, business plan, product development rollout schedule, and contract documents pertaining to a business development transaction involving the mated business development files; and business development transaction report engine 88 for generating a human-readable report of the complete business model of the mated business development files. Each of these components may interface with one another through network 47. Of course, such architecture is exemplary only, and those of ordinary skill in the art will readily recognize that all of these features may be provided simply as separate software modules on a single server computer.

Networks 45 and 47 may each comprise any network that will allow communication among the various elements of business development server system 35, and among business development server system 35 and the business enterprise users 25, expert knowledge holders 50, administrators 55, and databases 60, 65, and 70. Such networks may include the Internet, a Wide Area Network (WAN), a Local Area Network (LAN), “Internet Protocol—Next Generation,” and any variation of packet switched networks or other supporting technologies for permitting communication among servers and user systems.

Likewise, business enterprise users 25, expert knowledge holders 50, and administrators 55 may each be equipped with any system capable of interfacing with network 45 to communicate and interact with business development server system 35. Such systems may comprise personal computers, microcomputers, minicomputers, portable electronic devices, a computer network, or any other system operable to interface with network 45 to send and receive data. Likewise, such systems may be provided with operating systems and Internet web browsers for accessing and displaying data over a common network, as are well known in the art. Preferably, such systems do not require specialized hardware or software to access business development server 35.

Further, databases 60, 65, and 70 may comprise storage media employed to store data maintained by business development server system 35, and may include one or more physically distinct media, including, but not limited to, hard drives, floppy drives, CD-ROM, and any other existing or future existing storage technologies supporting ready access.

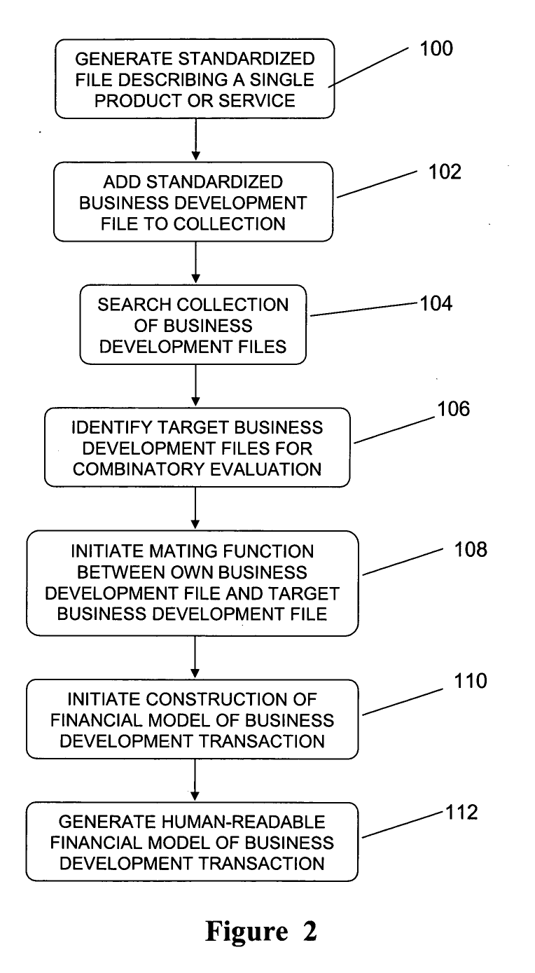

With regard to another aspect of the invention, a method is provided to standardize the business development process between independent parties so as to avoid the disadvantages associated with prior known methods of business development. As shown in FIG. 2, and as will be described below with regard to the technical implementation of such method, the first step of the generalized business development method of the instant invention concerns generating a standardized, computer-readable file at step 100 describing a single product or service that is offered by the user or by his or her company. Each such “business development file” is preferably generated by presenting the user with a series of questions that are designed at a level of detail to enable a typical business development professional to provide answers without requiring input from persons having specialized knowledge of the company.

After the business development file is generated by the user and added to a collection of business development files generated by other users at step 102, the user initiates or the system automatically initiates a search of the collection of business development files at step 104 to locate other business development files that exist in a particular market segment that is sufficiently complementary to the user's own market segment indicated in its own business development file to warrant investigation of a possible business development transaction between the user and other business development file owners. The user's “market segment” may include, for example, specific classes of products or services, business development transaction types, the user's own primary job function, and other information useful in describing the commercial environment for the user's product or service, as set forth in the knowledge base stored, for example, in market relationships library 65 (FIG. 1). As a result of performing the search, one or more target business development files are identified for evaluation at step 106, preferably with an indication of why the user may wish to pursue such evaluation (e.g., potential suitability for a new buy/sell arrangement, a new distribution agreement, a new technology transfer agreement, a new merger or acquisition, etc.).

After the user has identified one or more business development files for evaluation, the user initiates a mating function with the selected business development file at step 108. Such mating function solicits input from the user describing a hypothetical new product or service resulting from the combination of the user's business development file and the newly identified business development file. The information solicited from the user preferably includes: (i) an indication of the type of transaction to be carried out (e.g., new product development, technology license, reseller agreement, etc.); (ii) the responsibilities of each of the parties to the anticipated business development transaction; (iii) a description of the new product or service; (iv) a description of the anticipated market for the new product or service; and (v) a description of anticipated sales-related information for the new product or service (e.g., price, charge methods, number of sales, etc.).

After the mating function has been completed, at step 110 the user engages a model function that models the business development transaction by applying rules and mathematical formulas to the mated business development files to generate a human-readable, full financial model, business plan, product development rollout schedule, and contract documents relating to the business development transaction at step 112.

An example of one embodiment for carrying out the method of the present invention is illustrated in the next several figures. Such illustrations are by way of example only for describing the features of the present invention and are not intended to limit the disclosure in any way.

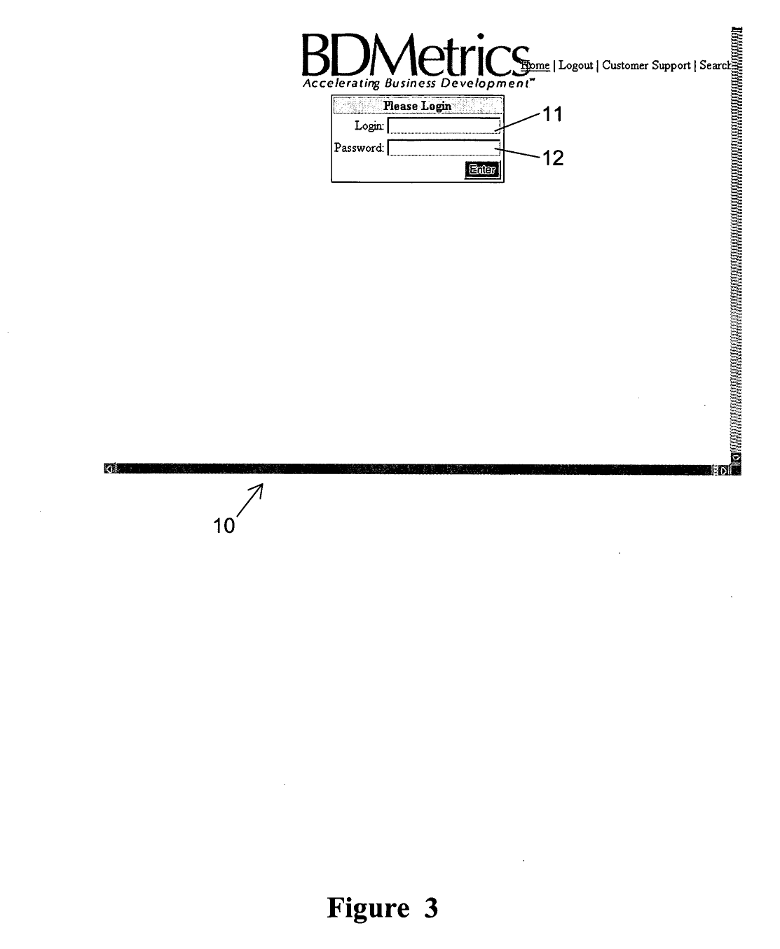

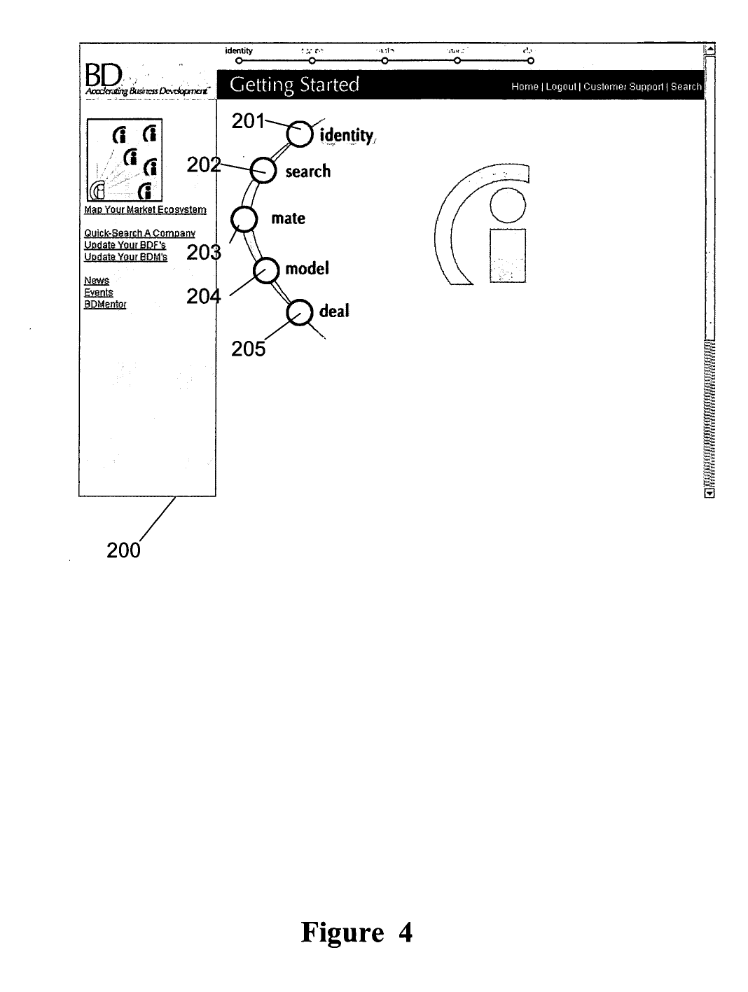

As shown in FIG. 3, the above-described method is initiated by first presenting a user with a login screen 10 that prompts the user to input a login identifier in data entry field 11 and a password in data entry field 12. Once the user has input a login identifier and password that are recognized by the system, the user is presented a start page 200 (FIG. 4).

As shown in FIG. 4, start page 200 preferably provides the user with access to five functionalities of the automated business development system, namely: (i) identity function 201, which enables the user to create a standardized, formatted description of its goods and services, and identify its goods and services to a specific market space; (ii) search function 202, which enables a user to search for products or services (and preferably for other providers of products and services) that may be sufficiently compatible to its own products or services to warrant an investigation of a business development transaction; (iii) mating function 203, which enables the user to define the parameters of a proposed business development transaction; (iv) modeling function 204, which applies business development and forecasting rules and formulas to the parameters input at mating function 203 in order to generate a financial model of the business development transaction, and which enables secondary users having specialized knowledge to customize the financial model; and (v) deal function 205, which formats information describing the financial model into human-readable reports detailing the complete business model of the business development transaction, including a full financial model, business plan, product development rollout schedule, and contract documents relating to the business development transaction.

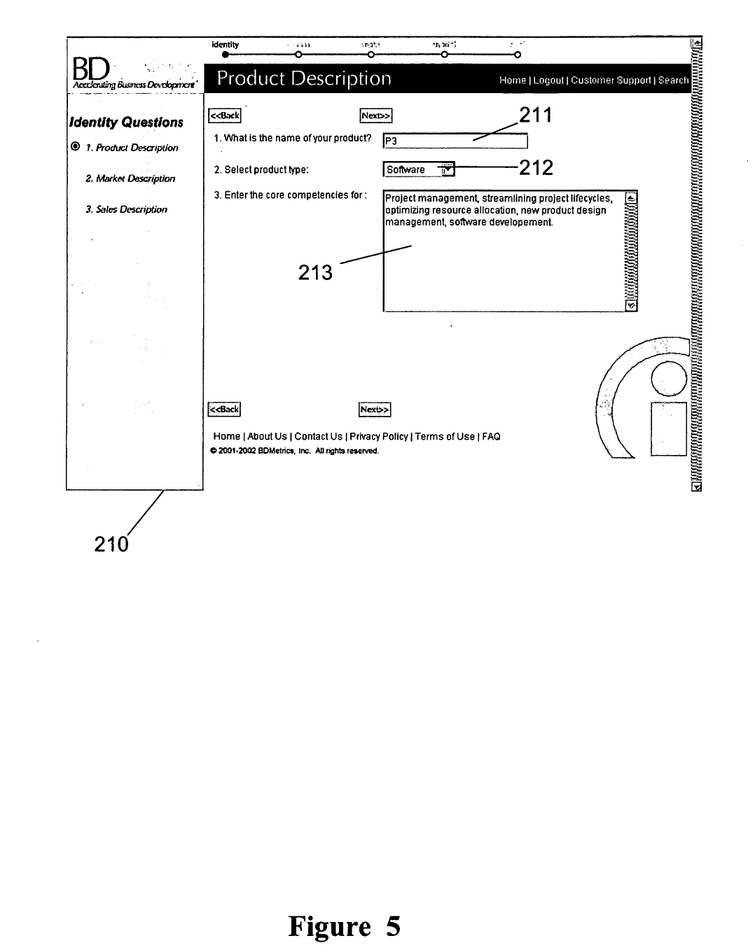

As shown in FIG. 5, when a user engages identity function 201, they are presented with a series of questions that are used to create a unique business development file that is descriptive of the user's goods or services. The business development file generated by identity function 201 is preferably a software object file, and more preferably a database record in a database accessible by a plurality of users over a computer network, such as business development file storage database 60 (FIG. 1), such database preferably containing a number of business development files created by multiple users. Preferably, a user, such as a company providing goods or services, will create a unique business development file for every product or service it offers, and for which such user wishes to explore business development opportunities.

In order to create a business development file, identity function 201 presents the user with a series of core business development questions, and prompts the user to provide responsive input to those questions, either by selecting an answer from a pull-down menu or by inputting text or numbers for open-ended questions. The questions presented to the user by identity function 201 can be categorized into two types, namely, general product information including a description of the product, its core competencies, and its market space, and revenue-specific information including market potential, charge methods, and general sales information. Each of the questions presented to the user by identity function 201 is of a sufficiently general nature that a business development professional will have the knowledge and background required to answer the questions without requiring assistance from others having specialized knowledge.

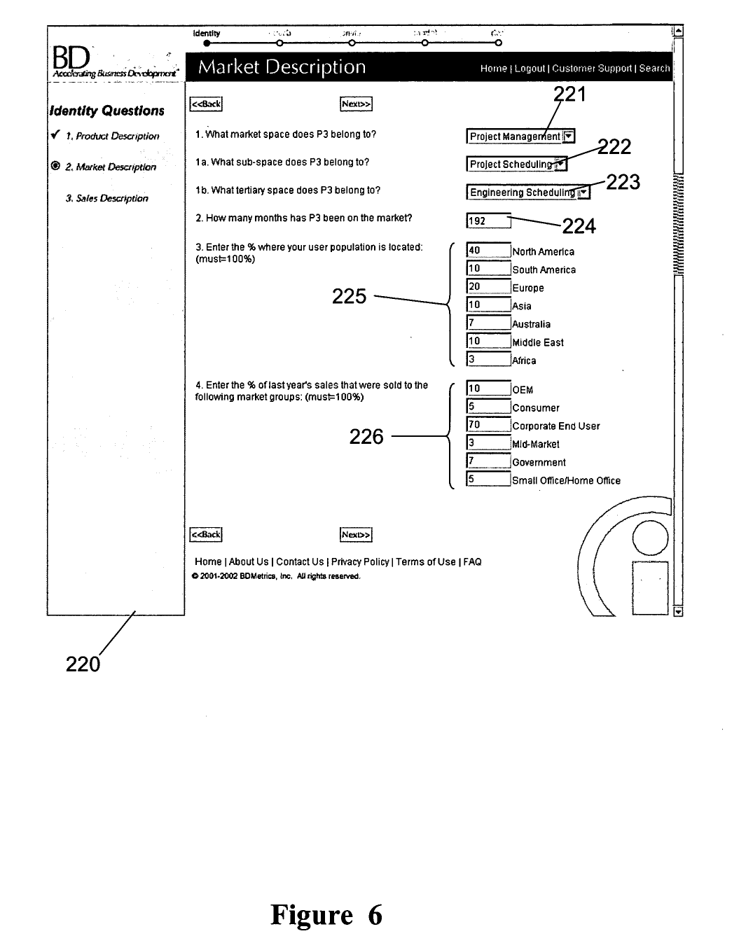

For instance, as shown in FIGS. 5 and 6, the questions relating to general product information preferably include a product description screen 210 and a market description screen 220. Product description screen 210 preferably prompts the user to input a product name in data entry field 211, select a general product type in data entry field 212 (e.g., software, hardware, silicon chip, consulting, services), and list the “core competencies” of the product or service in data entry field 213. As discussed in greater detail below, designation of a general product type in data entry field 212 assigns a number of default values to variables that will be used in modeling a business development transaction involving the product or service described by the business development file. For instance, by selecting “hardware” as product type, a first set of default values is assigned to variables used in calculations relating to sales projections, marketing expenses, costs of goods sold, and engineering schedules and workflows, while selecting “software” as a product type assigns a second set of default values to such variables, selecting “consulting” as a product type assigns a third set of default values to such variables, etc., such that the system may more specifically model a prospective business development transaction based upon the specific products or services at issue. Optionally, different levels of refinement of such default values are provided to enable precise customization for specific product types, while maintaining average values for broader product type categories. The selection of the exact values of such variables for any product type are established by experience in such market spaces and by general market analysis, and can thus readily be established and modified as needed by those of ordinary skill in the art.

In similar fashion, the core competencies input in data entry field 213 may optionally be used as yet another level of refinement of the default values of the variables used in modeling the business development transaction. Again, the selection of the exact values of such variables for any core competency are established by experience in the specific market spaces and by general market analysis, and can thus readily be established and modified as needed by those of ordinary skill in the art.

Likewise, market description screen 220 preferably prompts the user to select the market space for the particular product or service in data entry fields 221, 222, and 223, the time that the product or service has been on the market in data entry field 224, the geographical division of the market in data entry fields 225, and the market demography in data entry field 226.

The market space for the particular product or service is preferably defined in terms of a multi-level taxonomy, for example, a three-tiered taxonomy, namely, “market space,” which is selected in data entry field 221, “market sub-space,” which is selected in data entry field 222, and “market tertiary space,” which is selected in data entry field 223. A taxonomic library is stored in the system, such as in market relationships library 65 (FIG. 1), listing each market space, a number of market sub-spaces under each market space, and a number of market tertiary spaces under each market sub-space. By way of example only, a user might initially select “project management” from the list of possible market spaces, such list including a wide variety of market spaces, such as (by way of example only and not by way of limitation) “accounting and finance software,” “application server software,” “customer service software,” “engineering and design,” “human resources software,” “project management,” etc. Once the user has selected the particular market space, data entry field 222 provides a pull-down list of market sub-spaces associated with the designated market space in data entry field 221. For instance, the market space “project management” may provide market sub-spaces of “general project management,” “project accounting,” “project scheduling,” etc. Likewise, once the user has selected the particular market sub-space, data entry field 223 provides a pull-down list of market tertiary spaces associated with the designated market sub-space in data entry field 222. For instance, the market sub-space “project scheduling” may provide market tertiary spaces including “engineering scheduling.” As described in greater detail below, the product's or service's placement within this taxonomy enables the system to identify related market spaces, sub-spaces, and tertiary spaces, based on the association rules defined in a look-up table maintained by the system, in order to enable matching of the particular business development file with potential business development transaction partners.

The time that the product or service has been on the market as entered in data entry field 224 is used by the system to calculate the product maturity value, which value in turn calculates how many systems are sold per month or per year. The geographical division of the market as entered in data entry field 225 is used by mating function 203 to provide sales cycle values and channel collision information, i.e., to apportion sales staff of the parties to the business development transaction in order to provide sales coverage over specific geographic regions without overlapping the efforts of the sales staff. Likewise, the market demography as entered in data entry field 226 is used by mating function 203 to determine the number of sellable units that may be provided to each market segment, thus giving an indication of the overall compatibility of the product or service to each user population.

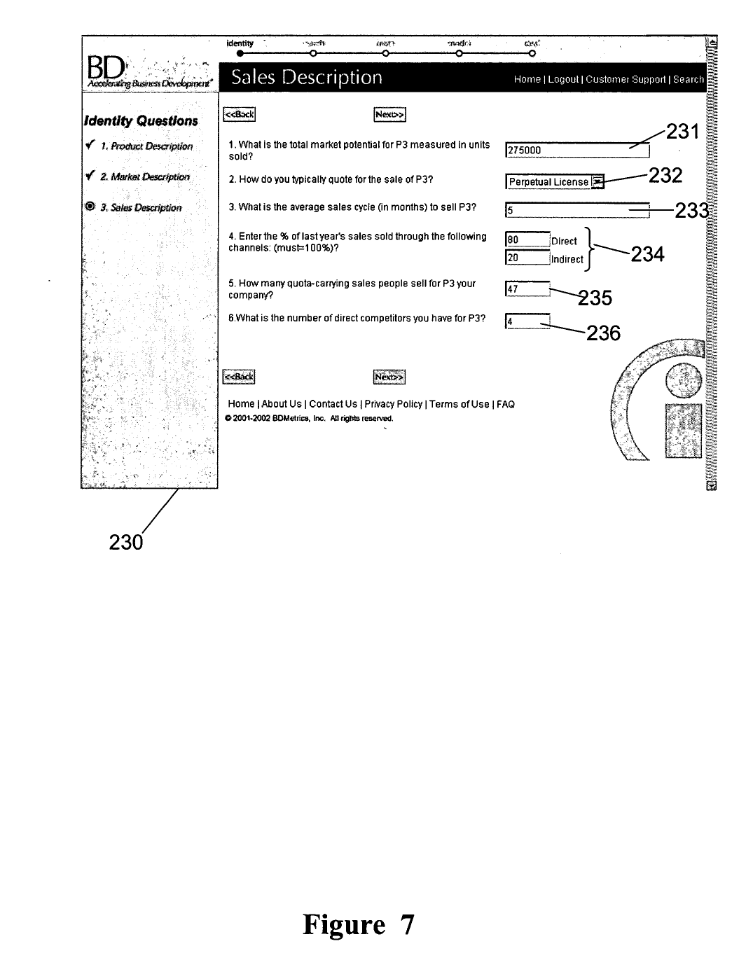

Likewise, as shown in FIG. 7, the questions relating to revenue-specific information preferably include a sales description screen 230 which prompts the user to input the total market potential (in units sold) for the product or service being described in data entry field 231, which market potential is then used by mating function 203 to determine the amount of time that it will take the company to successfully commercialize the product or service. Sales description screen 230 also prompts the user to select the method by which the price of the goods or services will be charged in pull-down data field 232 (e.g., annual license, perpetual license, term lease, flat fee, etc.), input the average sales cycle in data entry field 233, input the channels through which the product or service has been sold in the past in data entry fields 234, input the size of the sales staff for the product or service in data entry field 235, and input the number of direct competitors for the product or service in data entry field 236.

Notably, the charge type selected in pull-down data field 232 is particularly dependent upon the selected product type. Thus, selection of a first product type in data entry field 212 on product description screen 210 will cause a first listing of available charge types to be displayed in pull-down data field 232, while selection of a different product type in data entry field 212 will cause a distinct listing of available charge types to be displayed in pull-down data field 232. As described in greater detail below, each of these data items are used by mating function 203 to determine the amount and timing of costs and revenue from product and/or service sales.

As the information solicited throughout the identity function 201 is at a level of detail that is typically within the knowledge of business development professionals, such persons may readily create and modify business development files as they see fit, without depending upon expert knowledge from engineering staff, marketing staff, legal staff, or any other personnel.

Moreover, while not particularly shown in FIGS. 5-8, identity function 201 may also solicit the user's job function, for example, by instructing the user to select their particular job function (e.g., Design and Development Engineering Management, Systems Engineering, Financial Management, Product Marketing, etc.). As described in greater detail below, this information may be used to further refine search function 202.

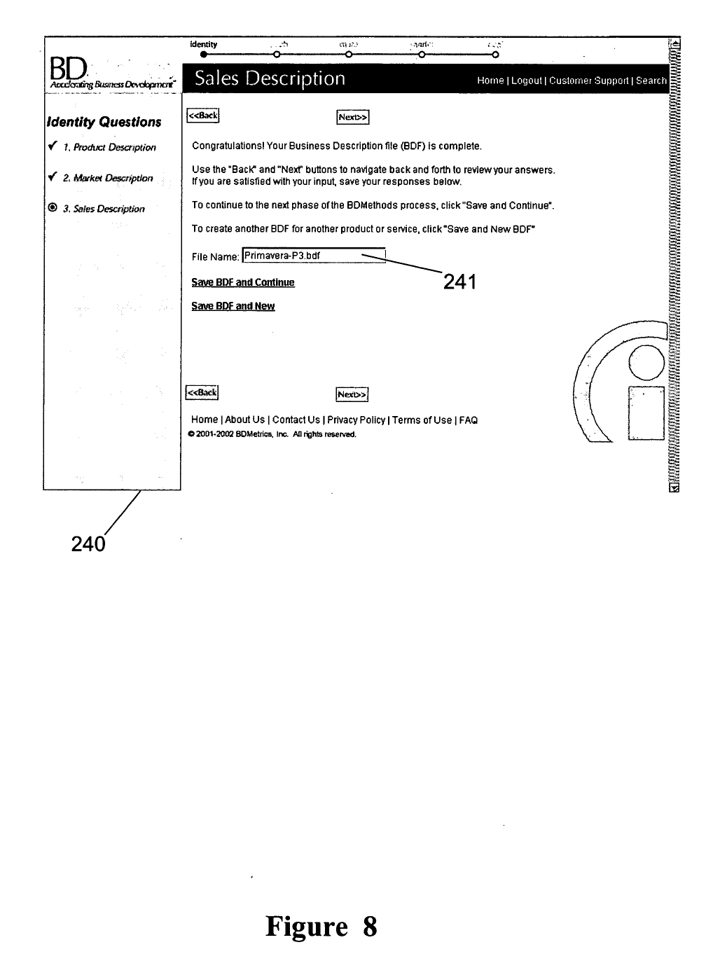

As shown in FIG. 8, after the user has answered the questions presented by the system through identity function 201, the user is preferably presented a completion screen 240 that enables the user to navigate through the previous screens to review the answers previously provided, enables the user to name the business development file in data entry field 241, and enables the user to save such newly created business development file to the system, such as by storing the business development file in Business Development File Storage Database 60 (FIG. 1) with a record identifier associating such business development file with the user. Further, as mentioned above, each saved business development file is preferably a database record in a database containing multiple business development files generated by multiple users. More particularly, the data used to build the business development file is preferably stored in multiple data tables maintained in a central database, such as Business Development File Storage Database 60.

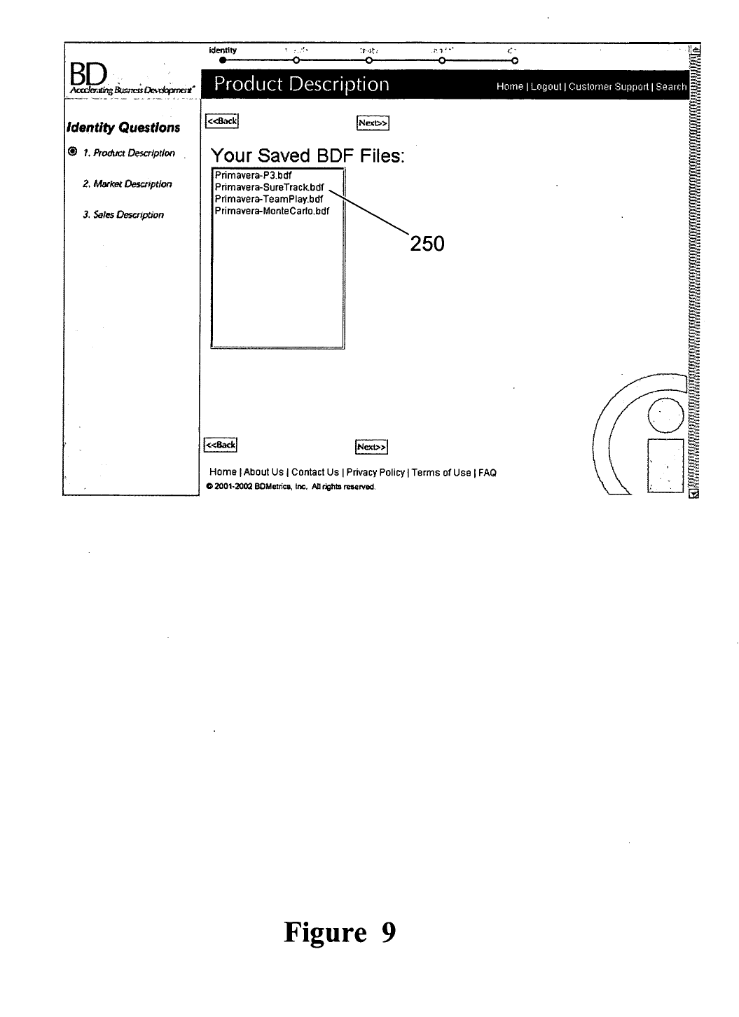

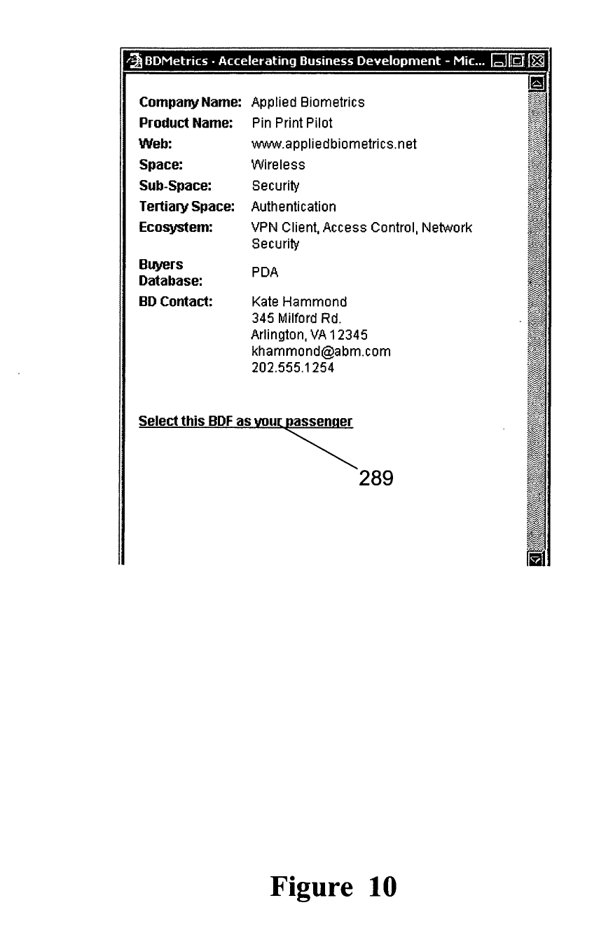

After the user has created and saved at least one business development file, they may likewise retrieve such previously created business development files for updating or editing. As shown in FIG. 9, after a user has created and saved at least one business development file, upon initiating identity function 201 or at any other suitable time in the process, that user may be presented a business development file list 250 listing previously created and saved business development files. A user may simply select one of the previously created and saved business development files from list 250, such as by clicking on the business development file name in list 250 using a computer mouse or other similarly configured pointing device as is known in the art, at which time the data associated with the selected business development file is extracted from the appropriate data tables and presented to the user. As shown more particularly in FIG. 10, the completed business development file is presented to the user in a format that quickly and succinctly presents a summary of the particular product or service it is intended to describe, and key background information relating to such product or service, such that a potential partner may quickly review the business development file and ascertain whether it reflects a technology which warrants further exploration of a business development transaction. More particularly, the formatted business development file preferably displays the product or service name, the company name, contact information for the business development contact at the company, the product or service market space, and the product or service “ecosystem,” i.e., the listing of market spaces that sufficiently relate to the product or service market space to warrant examination of a business development transaction. As discussed in greater detail below, such relations are preferably established by a set of rules that are maintained by the system in a look-up table, such that when the user identifies one or more market spaces to which its product or service belongs, the look-up table may be consulted by the system to determine the collection of other market spaces that correspond to the one or more user-identified market spaces.

Thus, the business development file generated by the user and saved to the system provides a data collection that is descriptive of the user's own product or service. By providing a standardized form for such data collection, a user's business development file is capable of comparison to business development files of other parties, such that computer-implemented, business-related rules and formulas may be applied to evaluate potential third parties with whom a user may wish to pursue a business development transaction, and generate a full financial model, business plan, product development rollout schedule, and contract documents relating to a business development transaction involving multiple business development files. Moreover, while the display of information stored in the business development file may be limited to the items noted above, the business development file comprises significantly greater detailed information relating to the user's product or service, which information is solicited throughout identity function 201, as described above. Thus, a user wishing to share his business development file with a potential business partner may do so, providing such potential partner with only general knowledge of the user's product and business, without disclosing the more sensitive and confidential business information that is necessary to accomplish mating function 203.

Following the creation of one or more business development files, a user may wish to search for business development files of other parties that might be suitable for evaluating a business development transaction. Search function 202 preferably enables a user to search for such products or services in three ways: (i) by conducting a manual search, in which a specific business development file of a third party is selected for evaluation; (ii) by conducting a targeted search, in which the user wishes to locate potentially compatible business development files within a particularly selected market space, sub-space or tertiary space; or (iii) by engaging the system to conduct an automated search, in which the system consults the relationship rules to locate the user's tertiary space in the look-up file and identifies all business development files in market tertiary spaces that are related to the user's tertiary space as possible candidates for a business development transaction.

As a preliminary step to searching for complementary business development files of third parties, the system may optionally enable a user to obtain an initial indication of third party entities that are most likely to have a product or service suitable for a business development transaction with user's own business, technology, product, or service. After a user's attributes that will comprise their business development file have been collected from the user and input into the system, the system may compare that user's attributes with those of other users registered with the system. Thereafter, the system may refer to a look-up table of potential connections that exist between, for example, the user's job function and those of other users registered with the system. Based upon the existence of such a connection between the user's job function description and the job function description of other users of the system, the system may generate output for the user in the form of a listing of the number of other system users having job function descriptions with a connection to the user's own job function description. The system may also provide the identities or business development file identifications for such users having complementary job function descriptions to expedite the user's search for complementary business development files.

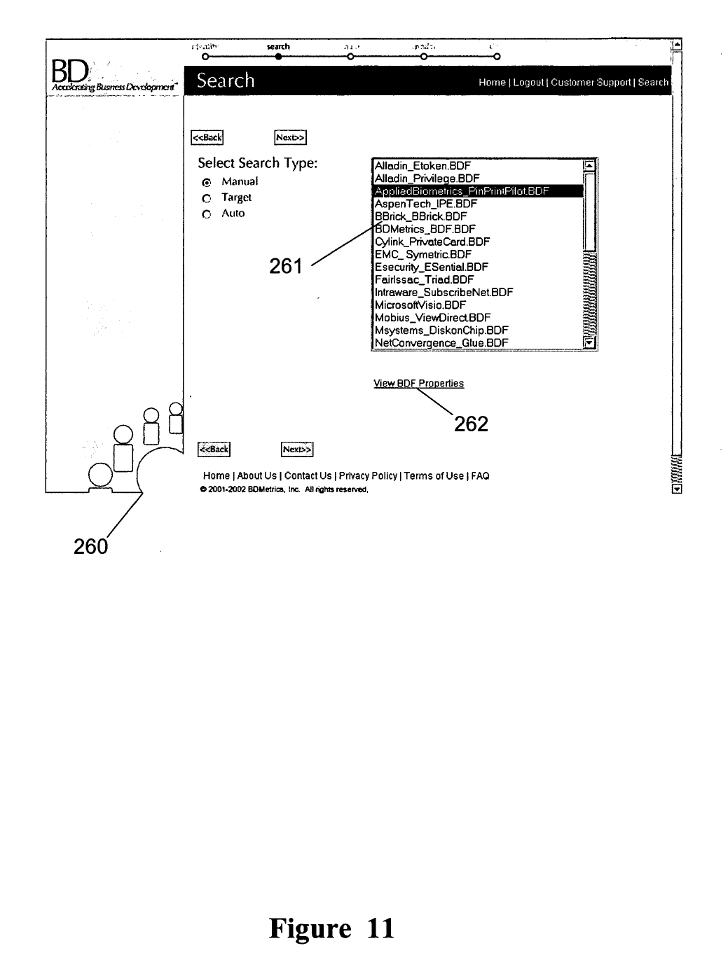

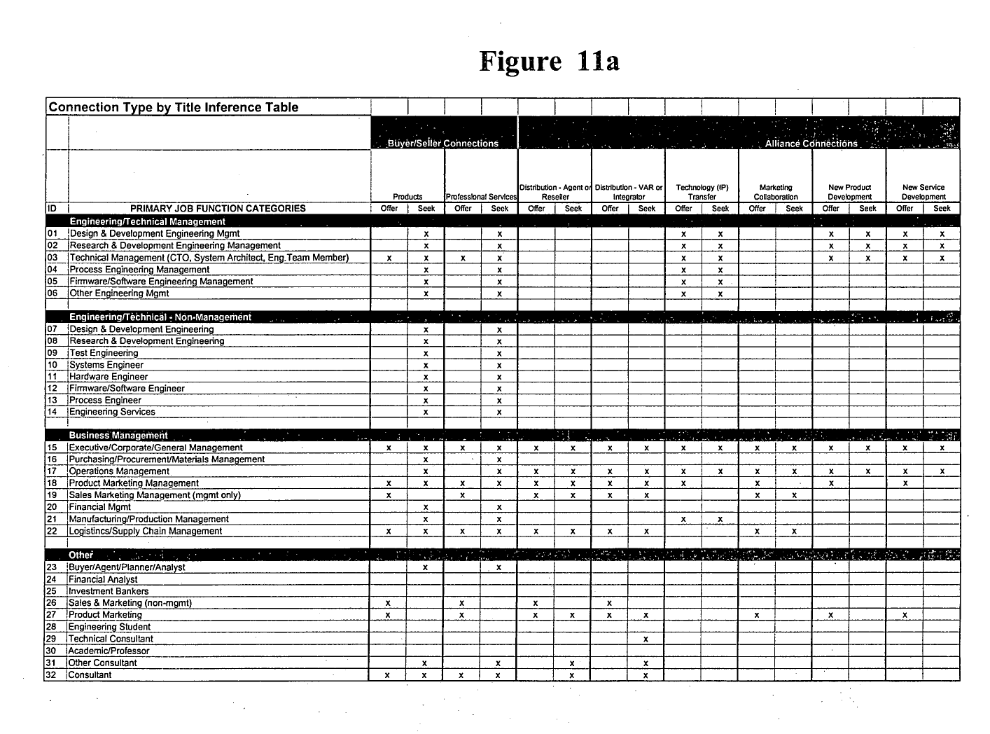

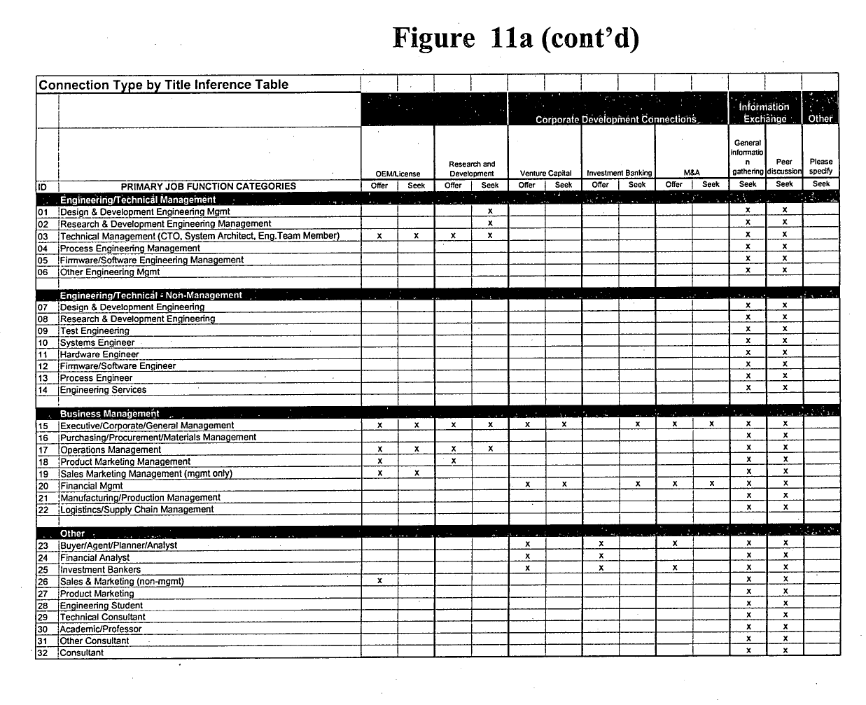

As used herein, “connection” is intended to refer to a relationship between the job function descriptions of users of the system and potential business development transaction types. For example, a connection may refer to the existence of a relationship between the job function of “Research and Development Engineering Management” and transaction types of (i) new product or service sale or purchase, (ii) technology transfer alliance, (iii) new product development alliance, etc. Market relationship library 65 (FIG. 1) may include a relational taxonomy of such job functions with particular transaction types. Thus, in such preliminary search, the system may provide the user with an indication of not only which third parties may be suitable for further investigation of a business development transaction, but also of why the user may wish to pursue such further investigation (e.g., for exploration of a new product purchase or sale, a technology transfer alliance, a cooperative new product development alliance, etc.), in turn streamlining the search function 202 as set forth below. An exemplary taxonomy is shown in FIG. 11a, although it is submitted that additional or varying relationships may exist and that the specific existence or non-existence of such a relationship between a specific job function and transaction type may be determined as necessary or desired by those skilled in the art.

As shown more particularly in FIG. 11, when a user initiates search function 202, the system presents the user with a search screen 260 which allows the user to select which method of search they will engage, i.e., manual, target, or automated. Particularly shown in FIG. 11 is a manual search configuration, in which the system displays to the user a listing 261 of every available business development file stored in the system database, enabling a user to select a particularly desired business development file by clicking on the appropriate file name. After the user has selected a particular business development file, they may display the particular business development file (in the format described above) by selecting the “View BDF Properties” function 262, which preferably displays the selected business development file in a separate window.

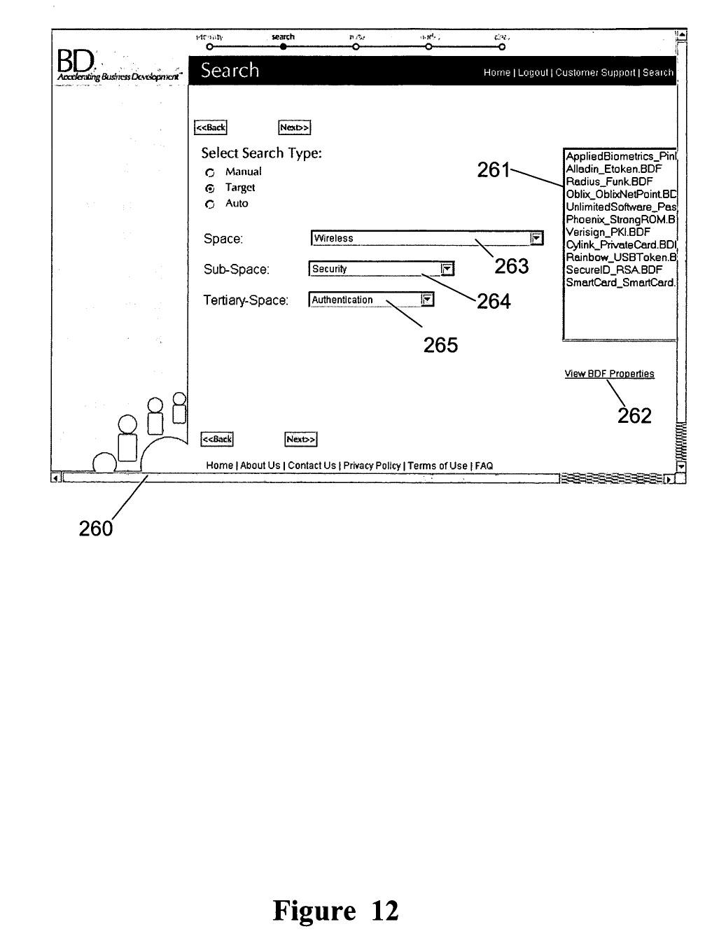

FIG. 12 illustrates search screen 260 after the user selects “target” as the desired search method. In this case, search screen 260 presents to the user a pull-down selection for a market space, market subspace, and market tertiary space in selection fields 263, 264, and 265, respectively. Notably, when the user selects a particular market space in selection field 263, market subspace selection field 264 presents the user only with market subspace selections that fall under the selected market space in selection field 263. Likewise, when the user selects a particular market subspace in selection field 264, market tertiary space selection field 265 presents the user only with market tertiary space selections that fall under the selected market subspace in selection field 264. As the user proceeds in making choices through selection fields 263, 264, and 265, listing 261 becomes progressively shortened, reflecting only those business development files that are present in the respective market space, subspace, and tertiary space. Thus, the user has the option of selecting business development files with which to mate at varying levels of specificity, namely, by market space, market sub-space, or market tertiary space. Once the desired level of specification is displayed (i.e., space, sub-space, or tertiary space), and the list of business development files present in such market space are revealed, the user may select and display a particular business development file from list 261 as explained above with regard to the manual search function.

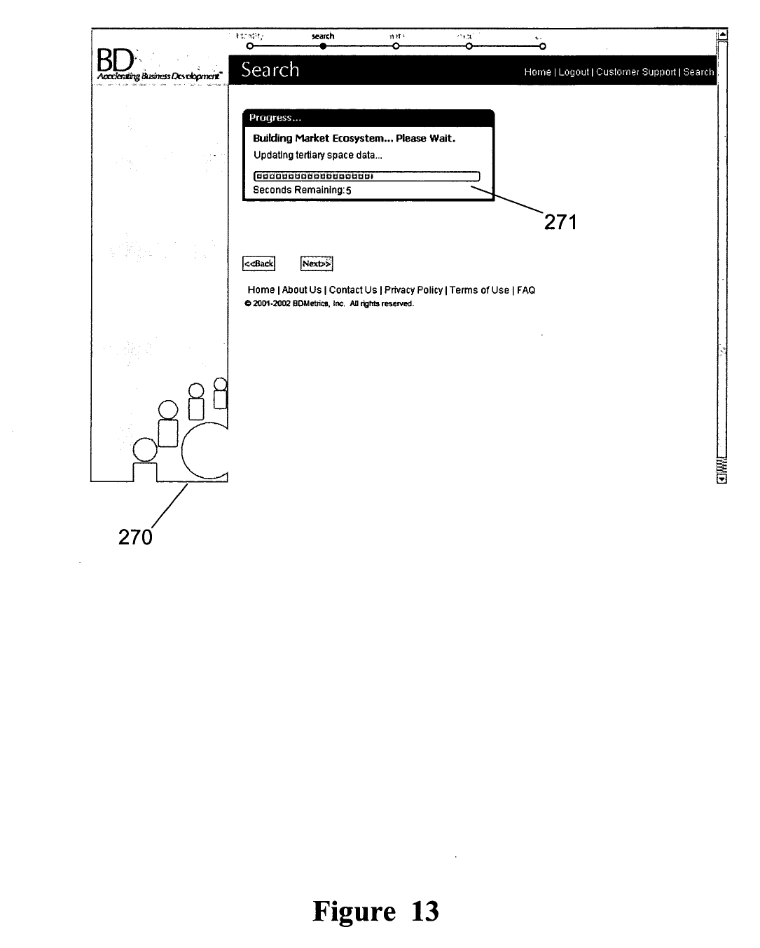

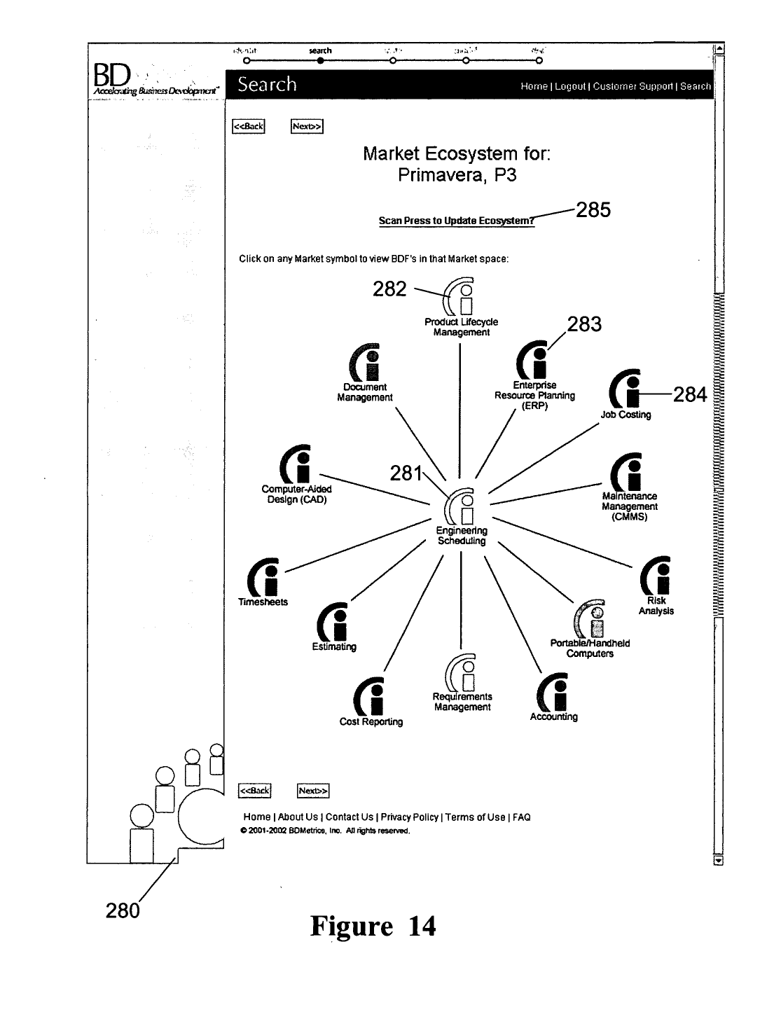

FIG. 13 illustrates an optional search status screen 270 that may be presented to the user after the user selects “auto” as the desired search method. In this case, search status screen 270 simply displays a status bar 271 as the system determines the market ecosystem for the user's business development file, i.e., those market spaces which, as stated in the association rules defined in the look-up table maintained by the system, bear a relation to the market space of the user's own business development file. Once the ecosystem has been determined, a graphical display 280 in the general form shown in FIG. 14 is presented to the user, which schematically presents the market ecosystem for the user's business development file. In the example depicted in FIG. 14, the user's market space of “engineering scheduling” 281 is noted as having a relationship with a number of other market spaces which may have sufficiently compatible business development files to warrant exploration of a business development transaction. In this example, the user's own market space 281 of “engineering scheduling” is noted as being related to such additional market spaces as “product lifecycle management” 282, “enterprise resource planning (ERP)” 283, “job costing” 284, and so on. Each related market space (282, 283, 284, etc.) contains one or more business development files corresponding to products or services existing within such related market space.

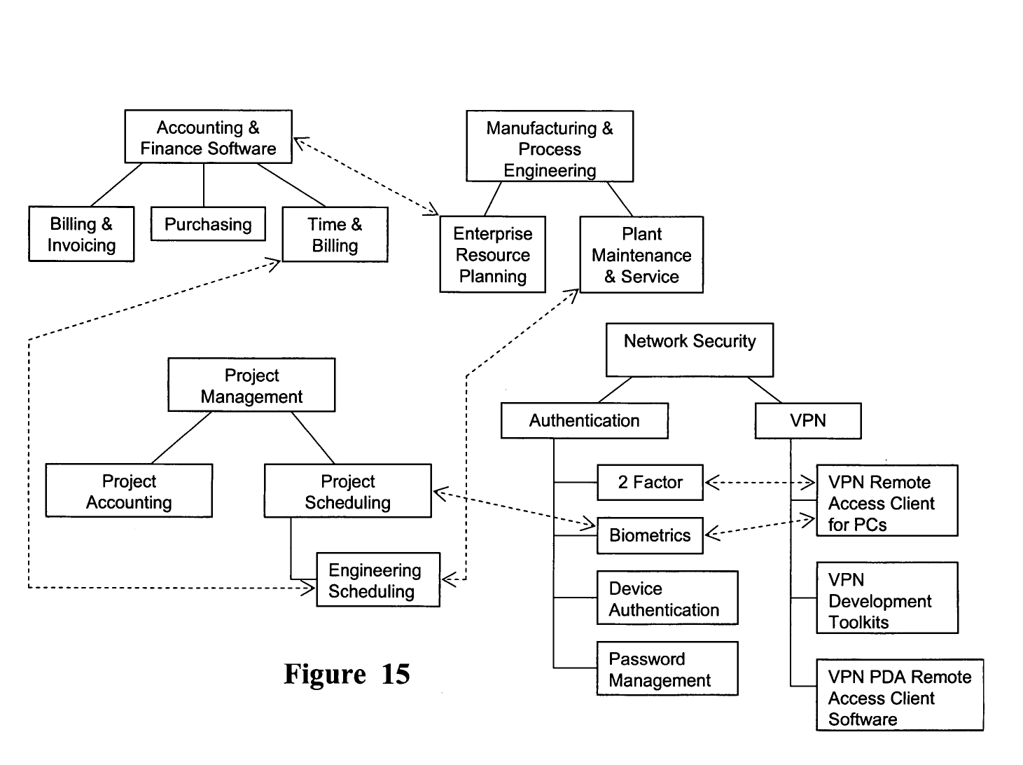

Notably, the market spaces depicted in the schematic display of the user's ecosystem need not all be tertiary spaces. Thus, the market relationship library may indicate relationships between and among market spaces, sub-spaces, and tertiary spaces. FIG. 15 is a schematic representation of an exemplary portion of the market relationship library reflecting this taxonomy. The schematic representation of FIG. 15 depicts the top-level market spaces “Accounting and Finance Software,” “Manufacturing and Process Engineering,” “Network Security,” and “Project Management.” As noted in FIG. 15, these top-level market spaces may have both sub-spaces and tertiary spaces associated with them, and at varying levels of specificity. In other words, some market spaces may be defined only at the top-level market space, while other spaces may be more specifically defined by sub-spaces, and still other spaces may be even more specifically defined by tertiary spaces. Thus, as depicted in FIG. 15, the top-level market space “Accounting and Finance Software” is further defined by market sub-spaces “Billing and Invoicing,” “Purchasing,” and “Time and Billing.” Likewise, the market space “Manufacturing and Process Engineering” is further defined by market sub-spaces “Enterprise Resource Planning” and “Plant Maintenance and Service.” Similarly, market space “Project Management” is further defined by market sub-spaces “Project Accounting” and “Project Scheduling,” with sub-space “Project Scheduling” being even further defined by market tertiary space “Engineering Scheduling.” Still further, market space “Network Security” is further defined by market sub-spaces “Authentication” and “VPN.” In turn, sub-space “Authentication” is further defined by market tertiary spaces “2 Factor,” “Biometrics,” “Device Authentication,” and “Password Management,” while market sub-space “VPN” is further defined by market tertiary spaces “VPN Remote Access Client for PCs,” “VPN Development Toolkits,” and “VPN PDA Remote Access Client Software.” Of course, the taxonomy shown in FIG. 15 is exemplary only and representative of only a portion of the market relationship library. Other market spaces, sub-spaces, and tertiary spaces may be provided, as desired.

In addition to the above-described market space, sub-space, and tertiary space hierarchy, the taxonomy of the market relationship library also includes relationships between and among the various spaces. If a relationship with a user's identified market space exists in the market relationship library, the automated search may reveal those spaces bearing a relationship with the user's market space when the user's market ecosystem is generated. As shown in FIG. 15, and by way of example only, the noted market spaces, sub-spaces, and tertiary spaces may have varying relationships among themselves. For instance, market space “Accounting Finance and Software” maintains a relationship with market sub-space “Enterprise Resource Planning”; market sub-space “Time and Billing” maintains a relationship with market tertiary space “Engineering Scheduling,” which also maintains a relationship with market sub-space “Plant Maintenance and Service.” Likewise, market tertiary space “VPN Remote Access Client for PCs” maintains a relationship with market tertiary spaces “2 Factor” and “Biometrics,” while market tertiary space “Biometrics” also maintains a relationship with market sub-space “Project Scheduling.” Thus, the market relationship library provides a web of relations between and among the various market spaces, sub-spaces, and tertiary spaces existing in the market relationship library. Such relationships may be modified, removed, or added as desired to reflect the various market space relationships that the user observes in practice.

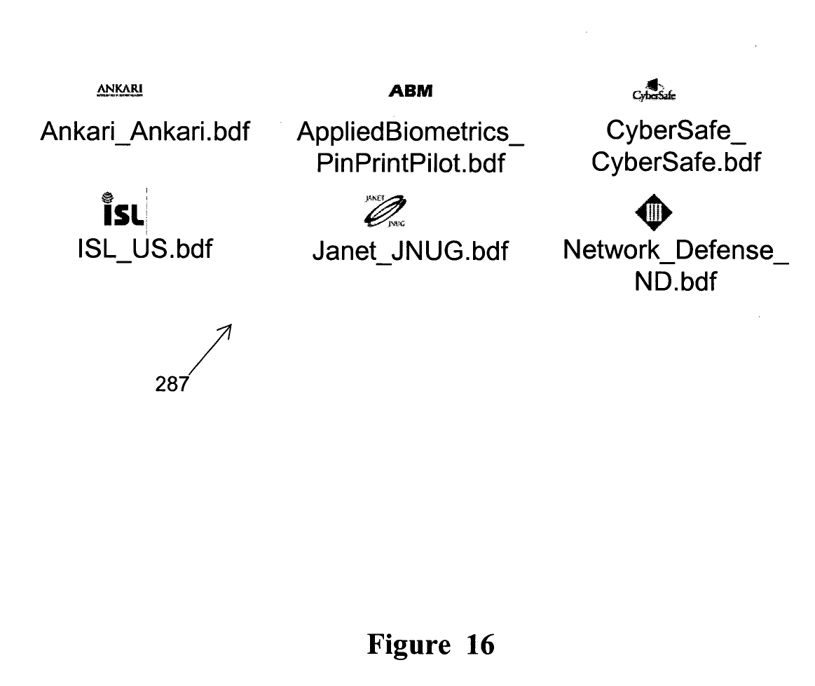

Referring again to the schematic market ecosystem shown in FIG. 14, preferably, by clicking on any related market space, the system presents the user with a market space display 290 listing those business development files that exist within such selected market space, as schematically shown in FIG. 16. In turn, when a user clicks on a single business development file icon on the market space display 287, the system preferably displays to the user the particularly selected business development file (in the format discussed above), and enables the user to select such business development file as the deal “passenger,” i.e., the business development transaction party that is to be simulated in the mating and modeling functions, by initiating passenger selection function 289 (FIG. 10).

Optionally, the system may further refine the results produced from search step 202 by creating a score quantifying the extent to which a particular business development file is complementary to another business development file. The weighted score is preferably automatically created by the system based on weights determined by a correspondence between the (i) market spaces, (ii) product types (e.g., software, hardware, services, silicon chip, consulting), (iii) market groups (e.g., OEM, corporate, consumer, mid-market, government, small/home office), and (iv) geographic markets (e.g., North America, South America, Europe, Asia, Australia, Middle East, Africa) of two separate products or services as set forth in their respective business development files. Market relationships library 65 (FIG. 1) may include a knowledge base providing a numeric quantification of a correlation (e.g., the numberic probability of a match) between any two market spaces, product types, market groups, or geographic markets. This numeric quantification may, in turn, comprise a portion of the overall score associated with a proposed combination of two products or services. By way of example only, the numeric quantification of correlation between market spaces may be 50% of the total score; the numeric quantification of correlation between product types may be 25%; the numeric quantification of correlation between market groups may be 12.5%; and the numeric quantification of correlation between geographic regions may be 12.5%. The correlations among particular market spaces, product types, market groups, and geographic regions are determined by experience and with reference to statistical data from analysis of such factors in practice, and may thus be set or modified as desired by those of ordinary skill in the art.

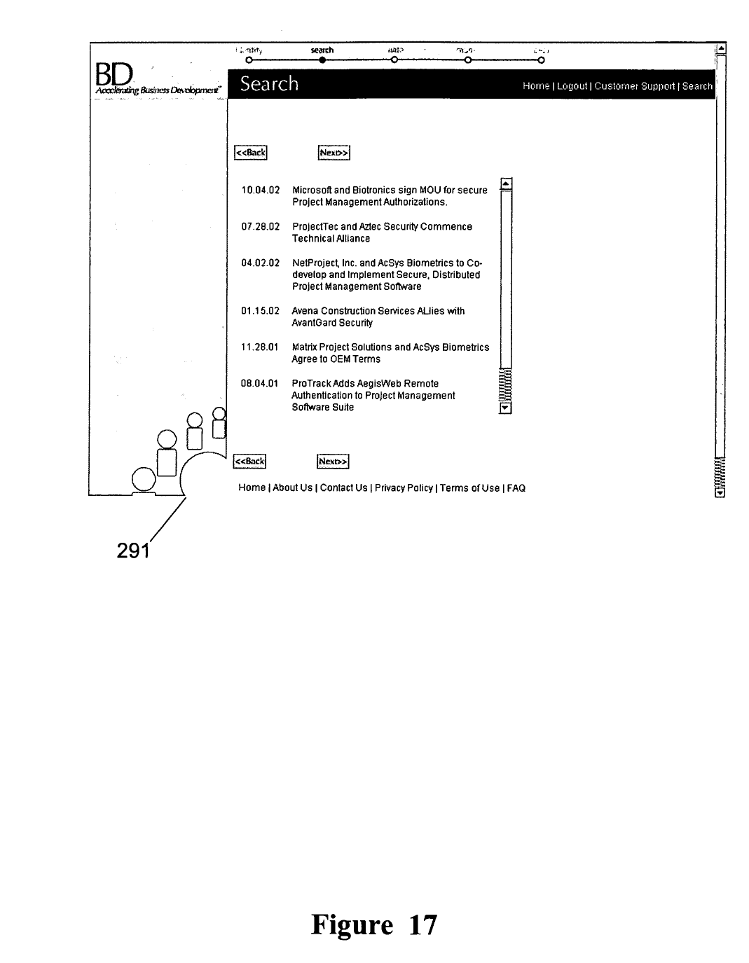

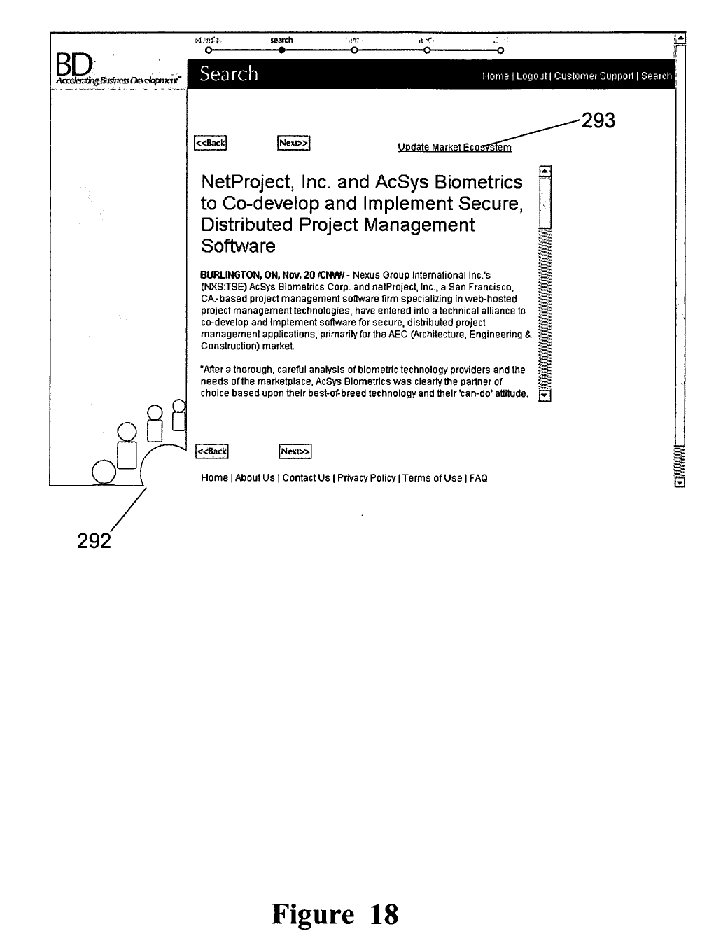

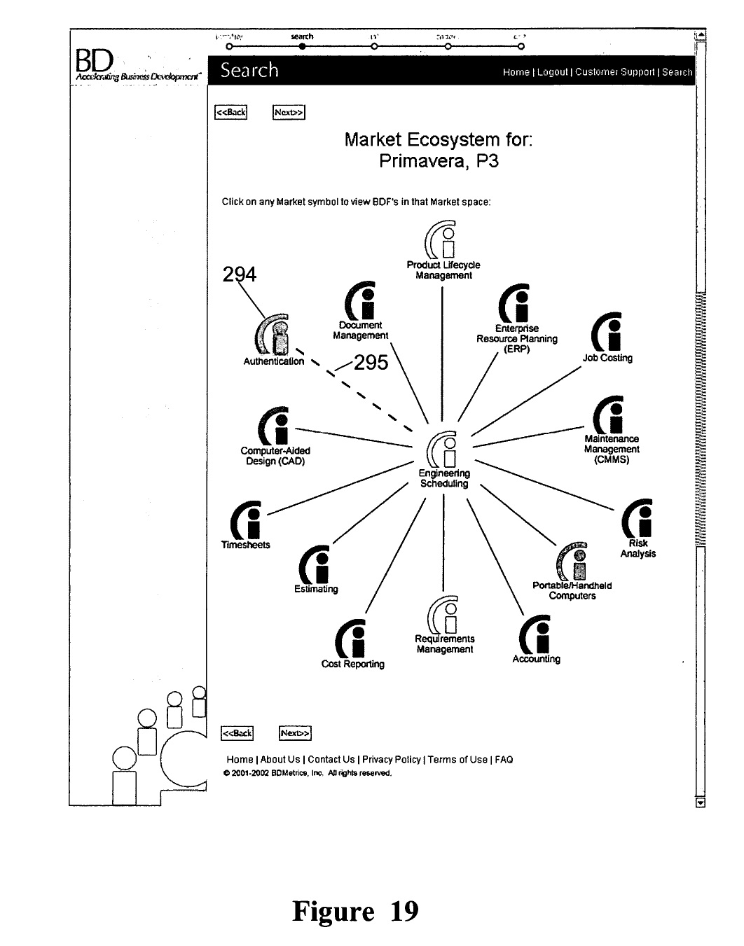

Optionally, an update feature may be provided enabling a user to update the market ecosystem for their identified market space by engaging a Scan Press function 285 provided on market ecosystem display 280 (FIG. 14). When a user initiates Scan Press function 285, the system initiates a search engine and generates a search query comprising the definition of the user's market space and terms relating to a business development transaction. While the generation of an appropriate query including terms relating to a business development transaction is known to those skilled in the art, by way of example such terms may include “joint venture,” “OEM,” “MOU,” “alliance,” “co-develop” and the like. Such search engines are widely commercially available, such as YAHOO, as well as other automated data mining tools, any of which may be used to locate press articles relating to the user's identified market space and other business development transactions. Once such articles are located, a list is generated and displayed to the user on a press article results display screen 291 as shown in FIG. 17. A user may select an article from the list displayed, at which time the full article will be displayed to the user on a full article display screen 292 (as shown in FIG. 18), thus enabling the user to read each article generated by the search. Each article display screen 292 preferably provides an update market ecosystem function 293 which, when initiated by the user identifies the related market space described by the article (by way of, for example, commercially available text recognition software), and adds an icon reflecting such market space to the user's market ecosystem display. As shown in FIG. 19, the new market space “Authentication” was identified and authentication icon 294 was added to the graphical depiction of the user's market ecosystem with a dashed line 295 indicating a potential relation to the user's “Engineering Scheduling” market space. If the user then selects the newly designated market space “Authentication,” a listing of business development files present in that market space are displayed, enabling the user to select one or more of such business development files as the passenger for mating function 203.

Thus, search function 202 provides the user with an automated engine for finding products and/or services of other business enterprises that are present in market spaces that are sufficiently comparable to the user's own identified market space to warrant investigation of a business development transaction. While the user may manually select a specific business development file of another party or search by a particular market space, sub-space, or tertiary space, the system also provides an automated search tool that receives the user's business development file, reads the user's market space from the business development file, consults the market relationship library to define the user's market ecosystem (i.e., identify business development files in market spaces that the relationship library indicates are related to the user's own market space), displays the related market spaces, allows the user to select one or more of the related market spaces, displays the individual business development files present in the selected market space, and allows the user to select a specific business development file in the selected market space for mating.

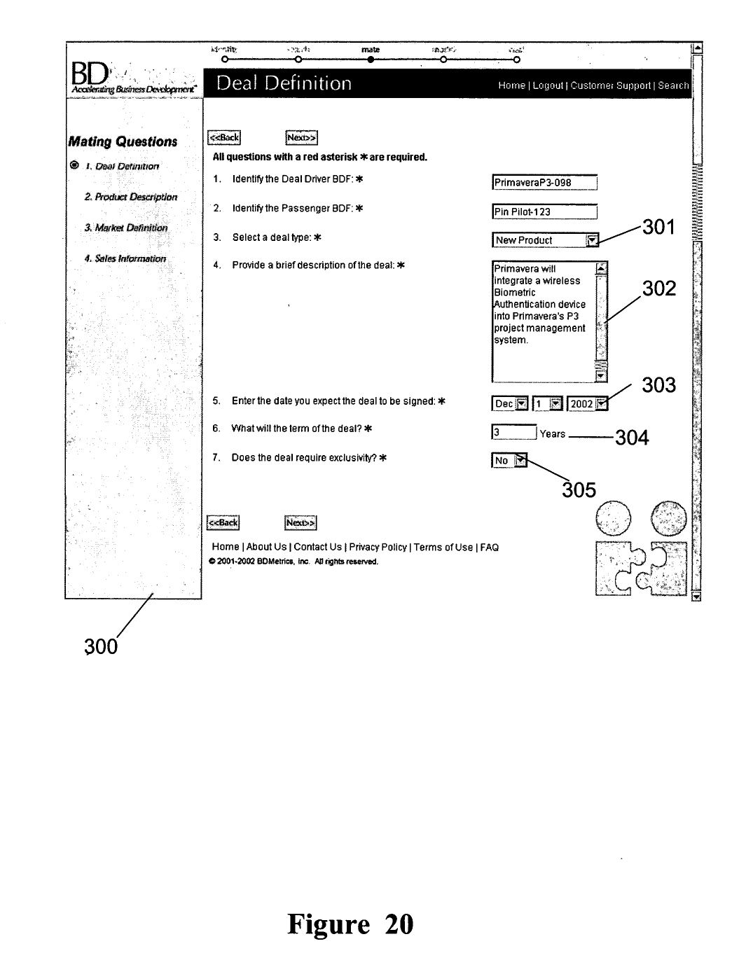

After the user selects a particular business development file as a passenger, the system automatically engages mating function 203, which enables the user to define the parameters of the business development transaction. As shown in FIG. 20, when mating function 203 is initiated, the system displays a deal definition screen 300 that presents the user with a series of questions, the answers to which will further customize the business development-related formulas, equations, and value assumptions to be applied to generate the business model. More particularly, deal definition screen 300 prompts a user to select a deal type in selection field 301, such as “new product,” “reseller agreement,” “technology license,” etc. Each deal type preferably provides a set of mathematical calculations that are used to generate a financial model of the business development transaction, such calculations being particularly adapted for the selected deal type. The precise equations used in such calculations, e.g., calculation of three year revenue stream for a new product launch versus a technology license, are considered within the level of ordinary skill in the financial arts, and are determined based on historical sales data for various products in various markets. Thus, such formulas may be modified, adapted, or supplemented as particular market conditions may indicate. However, it should be noted that such calculations should extend to the determination of those items reflected by model function 204, as discussed in greater detail below.

Moreover, it should be noted that the particular equations used in the calculations, and more particularly the default values for variables in those equations (such as typical employee salaries, typical marketing costs, typical royalty rates, etc.) that are present in Business-Related Formulas/Equations For Modeling Database 70 (FIG. 1) are adapted to particular product types, and thus are themselves subject to a specific hierarchy. More particularly, for each market space that exists as a bottom level market space in the system hierarchy, there exists a library of assumptions providing default values. Such default values are preferably organized by business personalities, namely, sales default values, engineering default values, finance default values, marketing default values, and legal default values. Thus, the system hierarchy (stored in database 70) enabling customized default values for specific product types is, for example, configured as follows:

Particular Market Space

Sales Default Values

Hardware (Product Type I)

Software (Product Type II)

Services (Product Type III)

Silicon Chip (Product Type IV)

Consulting (Product Type V)

Engineering Default Values

Hardware (Product Type I)

Software (Product Type II)

Services (Product Type III)

In addition to being subject to the product type hierarchy noted above, the questions relating to the deal that are presented to the user by mating function 203 are also dependent upon the designated deal type input in data entry field 301. In other words, selection of “new product” deal type will apply a first set of equations for modeling the business development transaction, while selection of “technology license” as the deal type will apply a second set of equations, and so on. Again, the particular equations applied for varying deal types are the subject of ordinary financial skill, and may be modified or supplemented as necessary for particular deal types and product types.

In order to maintain, modify, and supplement the default values noted above, the system preferably enables expert knowledge holders 50 and system administrators 55 (FIG. 1) to access the business development server system through a secured interface prohibiting access to unauthorized persons. Such expert knowledge holders 50 and administrators 55 may modify or add to the default values stored in Business-Related Formulas/Equations Database 70 as market conditions change or as otherwise becomes necessary. Preferably, in addition to maintaining, modifying, and supplementing the formulas and equations in database 70, such expert knowledge holders 50 and administrators 55 may also provide generic business development files to Business Development File Storage Database 60. Thus, where no users have yet generated a business development file in a particular market space, the expert knowledge holders 50 and administrators 55 may create a generic business development file in such market space, thus enabling users to evaluate hypothetical business development transactions even in such unpopulated market spaces. Of course, users may likewise create hypothetical business development files in market spaces in which they wish to investigate a possible business development transaction.

In addition to soliciting an indication of the particular deal type from the user, deal definition screen 300 prompts a user to provide a brief description of the deal in text field 302, to provide a date on which the deal is expected to be signed in data entry field 303 with the term of the deal in data entry field 304 (which dates/durations in turn are used by modeling function 204 to determine the timeline for sales cycles, revenues, product engineering, etc.), and to indicate whether the deal requires exclusivity in selection field 305. The exclusivity indication in turn is used by modeling function 204 to effect sales cycle, market size, sales price, etc. In the event that the user indicates that the deal will require exclusivity, deal definition screen 300 preferably displays additional questions relating to the exclusivity, including: (i) prompting the user to select whether the exclusivity is based on market group or geographical market, and an indication of such market group or geographical market; (ii) prompting the user to provide the term of the exclusivity; (iii) prompting the user to select whether there is an annual minimum order associated with deal exclusivity, and if so, the annual minimum order amount associated with the deal exclusivity; and (iv) prompting the user to input a textual explanation of the exclusivity agreement, which textual explanation will be incorporated in a Term Sheet Report as explained in greater detail below.

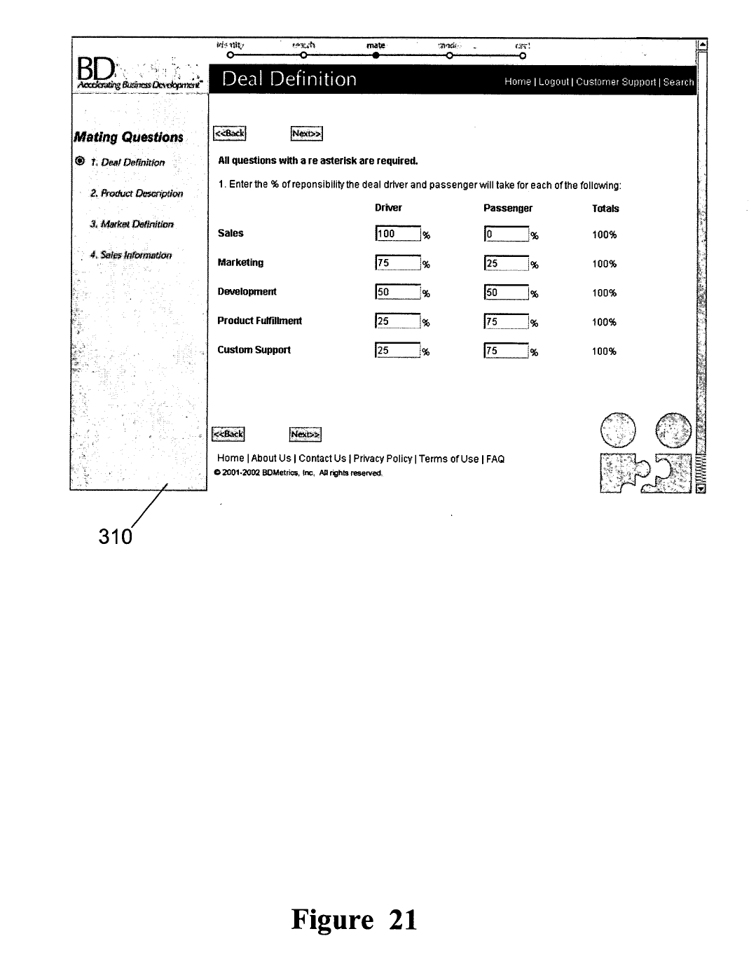

After the above-described data is entered into deal definition screen 300, a second deal definition screen 310 is presented to the user, as shown in FIG. 21. Deal definition screen 310 enables the user to input the areas of responsibilities of each of the parties to the business development transaction, preferably including the areas of sales, marketing, development, product fulfillment, and custom support. When initially presented to the user, each of the data entry fields in deal definition screen 310 are preferably pre-populated with default answers stored in database 70, as described above. As mentioned above, a set of such default values exists for each product type 212 selected by the user in product description screen 210 (FIG. 5). However, the user is able to override these default values simply by entering an alternate value in the appropriate data entry field. The values that are input by the user (or accepted by the user in the case of default values) are in turn used by modeling function 204 to determine the costs that will be incurred by the driver, and thus the revenue and other financial parameters that the user will realize.

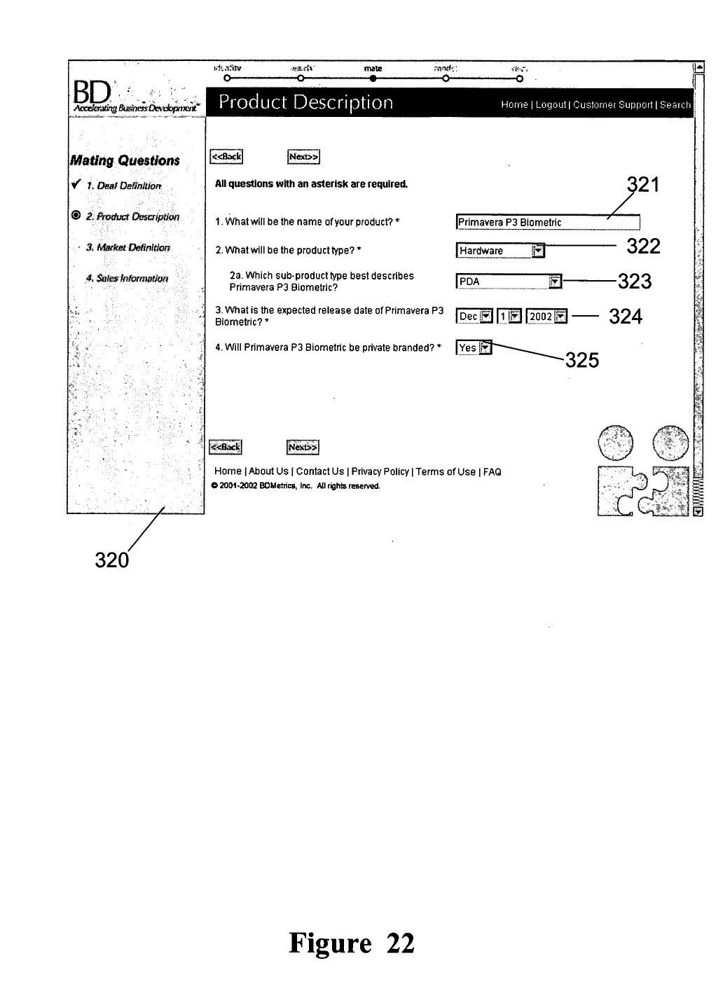

After the user has input the separate responsibilities of the parties to the business development transaction, the system presents the user with a product description screen 320 as shown in FIG. 22. Product description screen 320 prompts the user to input a name for the new product or service in data entry field 321, select a product type (e.g., hardware, software, silicon chip, wireless server, consulting, services) in selection field 322, select a sub-product type associated with the selected product type in selection field 323, input the expected release date of the product or service in data entry field 324, and indicated whether the new product or service will be private branded in selection field 325. As mentioned above, selection of the particular product type determines the formulas and equations that are to be applied by modeling function 204 to generate a financial model of the business development transaction.

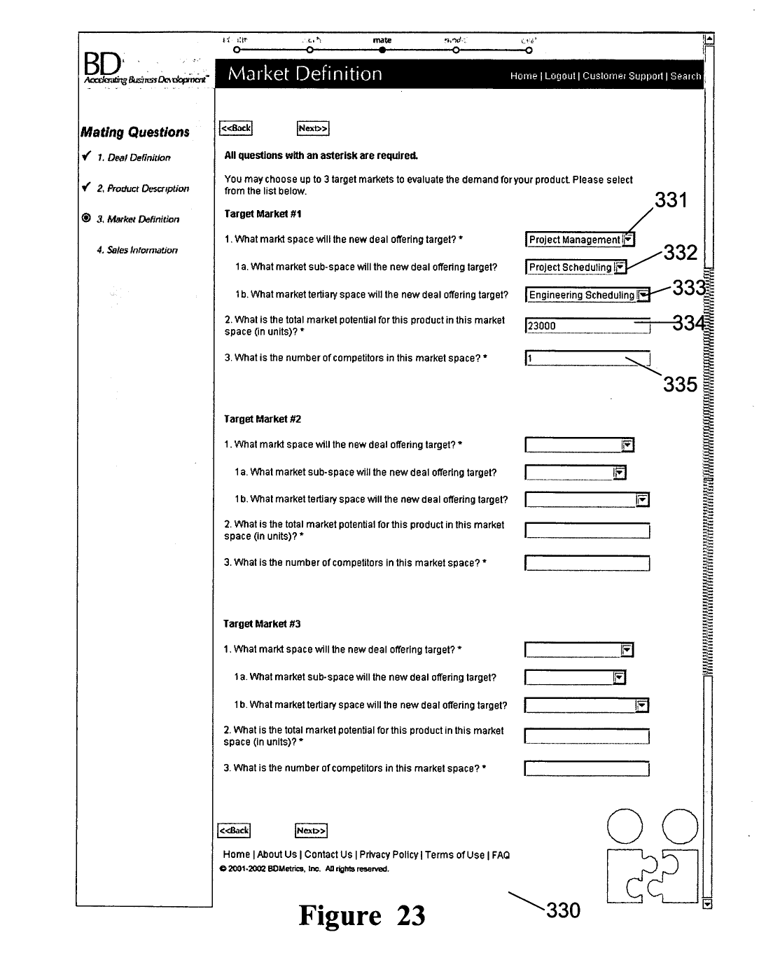

After the user has described the new product or service, the mating function 203 presents the user with a market definition screen 330 as shown in FIG. 23. Market definition screen 330 preferably prompts a user to define the market space, market sub-space, market tertiary space, etc. in data fields 331, 332, and 333, respectively, as they did when creating their own business development file. After designating such market space, market definition screen 330 prompts the user to input the total market potential for the new product or service in the designated market space in data entry field 334, and the number of competitors in the designated market space in data entry field 335. Preferably, market description screen 330 enables the user to designate up to three target markets for the new product or service.

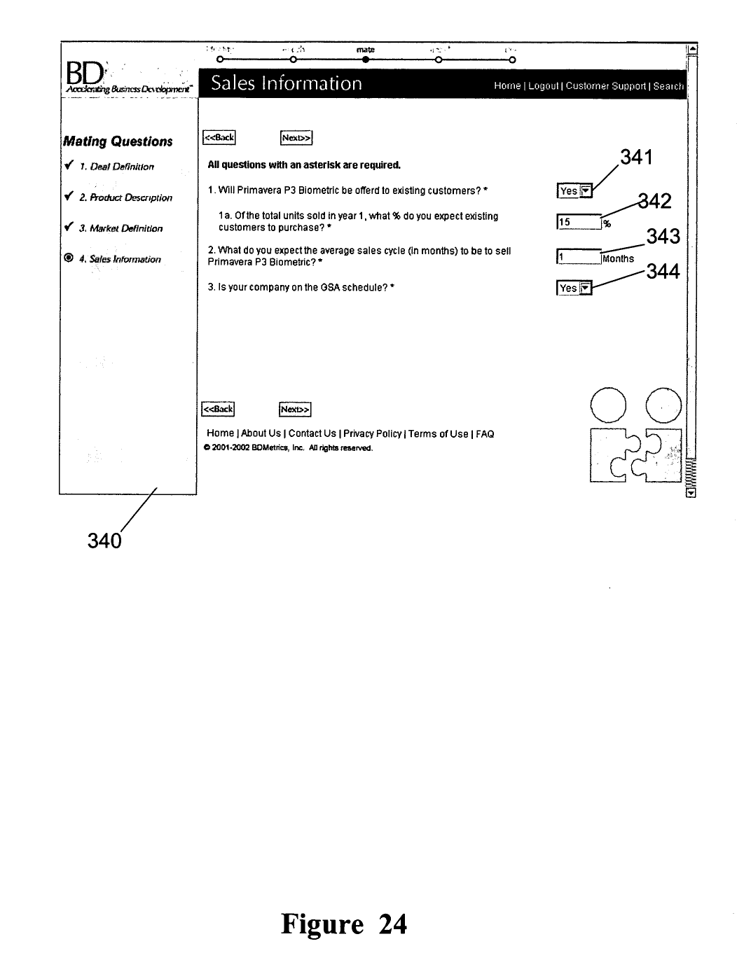

Following the description of the market for the new product or service, mating function 203 presents the user with a sales information screen 340 as shown in FIG. 24. Sales information screen 340 preferably prompts a user to provide an indication of whether or not the new product or service will be offered to existing customers in data selection field 341, and if so, the number of units sold in the first year of the business development transaction to existing customers, input as a percentage of total number of units that will be sold in that first year in data entry field 342. Sales information screen 340 also preferably prompts a user to input the average sales cycle, in months, for the new product or service in data entry field 343, which value overrides the existing sales cycle. Likewise, sales information screen 340 preferably prompts a user to select whether or not the business development transaction driver's company is on the GSA (U.S. General Services Administration) schedule in data selection field 344. If the user indicates that they are on the GSA schedule, modeling step 204 adjusts the timing of revenue based on the number of sales to government entities, and particularly accounting for timing of payment based on government procurement cycles, and amount of payment based upon the standard discount applied to purchases made by the government for products and services listed on the GSA schedule.

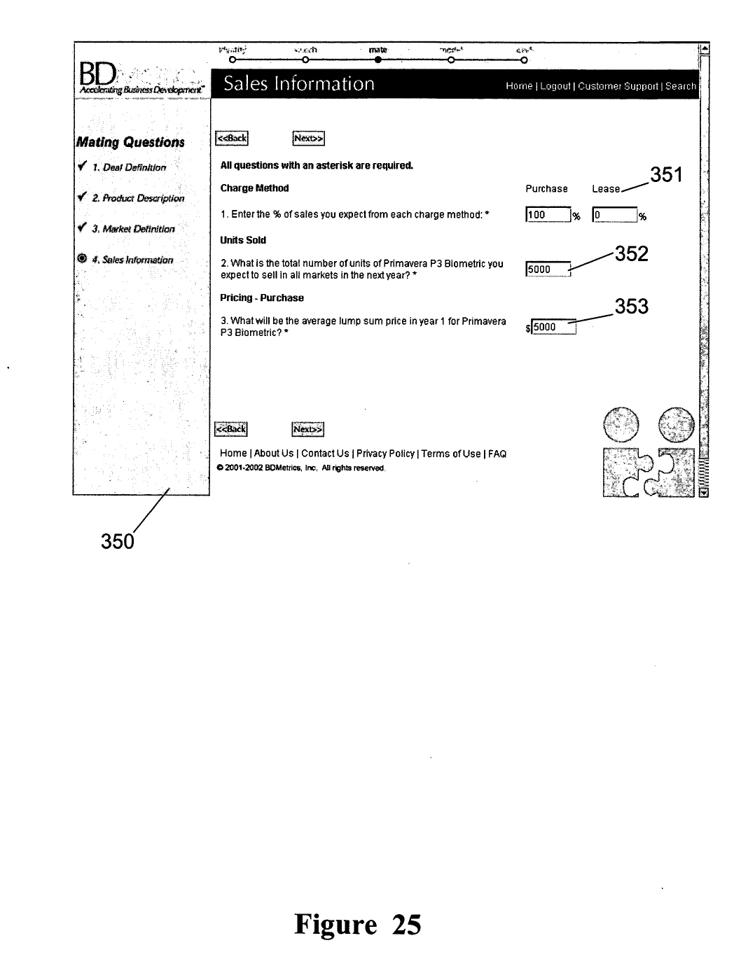

Following completion of sales information screen 340, mating function 203 preferably presents the user with a second sales information screen 350 (as shown in FIG. 25) which solicits additional information from the user concerning quantity and pricing matters. More particularly, sales information screen 350 preferably prompts a user to indicate the method by which the new product or service will be billed in data entry field 351. Likewise, mating function 203 prompts the user to indicate the number of units that the user expects to sell in the next year in data entry field 352, and the average lump sum price in the first year for the new product or service in data entry field 353. As explained in greater detail below, each of these values is used by modeling function 204 to enable cost and revenue forecasting.

After the user has completed data entry in mating function 203, the user is prompted to save the mating data as a business development mating file. The user may assign a name to the business development mating file, and elect to save the file to a database containing a plurality of mating files generated by a plurality of users. Preferably, the business development mating file is stored with an identifier associated with the user who generated that file, such that the user may, later quickly retrieve any previously generated business development mating file by selecting the same from a list of all business development mating files associated with that particular user. After the user has thus completed mating function 203 for at least one new product or service, the user may elect to engage modeling function 204 to generate a complete financial model, business plan, product development rollout schedule, and contract documents for a business development transaction relating to a previously generated business development mating file. When the user initiates modeling function 204, they are initially prompted to select a business development mating file that they have previously generated and saved to the system. Preferably, a list of all previously generated business development mating files is presented to the user for review, which list enables a user to select a particular mating to model using modeling function 204. Once the user selects which business development mating file they wish to model, modeling function 204 initiates a personality input function which enables persons having specialized knowledge of particular facets of the business development transaction, such as engineering, sales, marketing, and legal personnel, to review the business development mating file and provide more customized and detailed information relating only to their own specialized area of knowledge. Such knowledge-specific customization enables the user to create a refined model of the business development transaction. The refinement provided by the specialized input of various personalities associated with the user's company provides a more precise model, enabling such specialized knowledge holders to override default values associated with each product type, market space, and the like, to indicate the costs, schedules, pricing, advertising, and the like, associated with the user company's own unique sales, marketing, engineering, etc. practices. To enable such individualized customization, during mating step 203, a user preferably inputs an email address for each personality that is to provide input to the financial model. After model step 204 has been completed, the user may initiate a “personality play” function that automatically directs an email link to the personalities identified by the user, with a request that such person analyze the key values relating to their particular personality. Preferably, only those values that relate to the receiving person's personality are displayed to that person in their email message. Once each personality has input there own data to further customize the model, model function 204 may be rerun to further refine the details of the model.

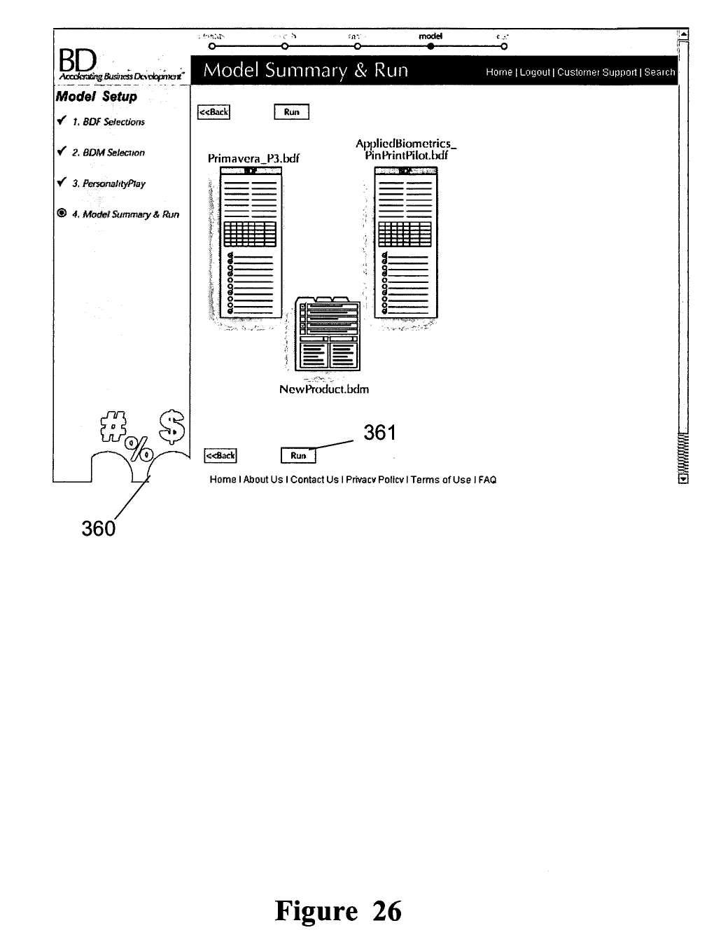

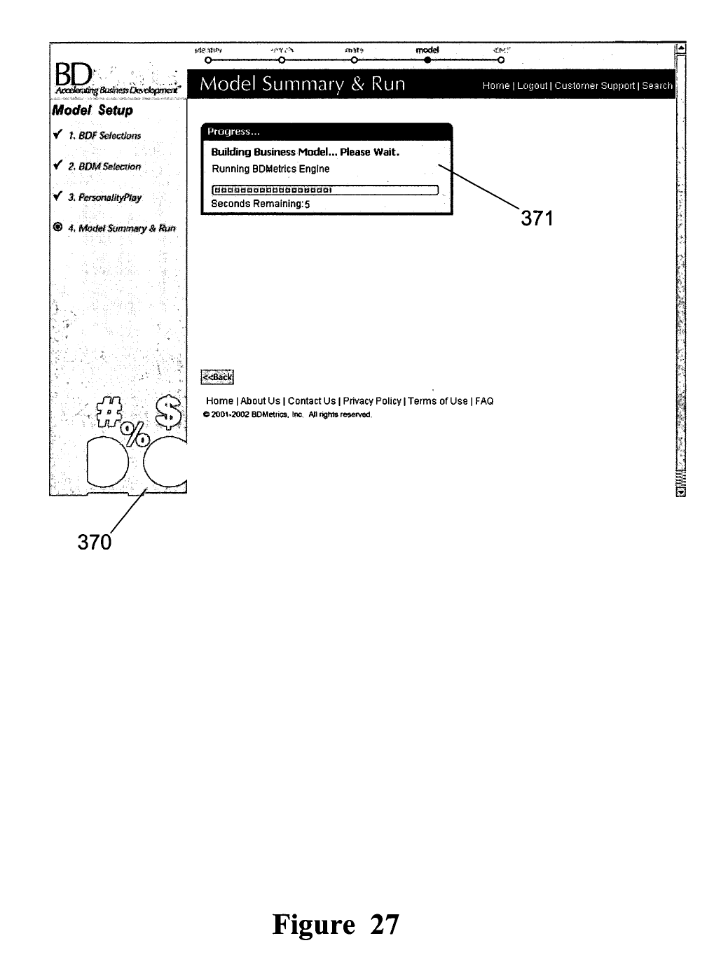

After the various personalities have provided their specialized input to refine the details of the model, as shown in FIG. 26, modeling function 204 presents the user with a model summary and run screen 360 that preferably displays the business development mating file that has been selected for modeling, and the two business development files that were used to generate the business development mating file to be modeled, and prompts the user to initiate construction of the full financial model, business plan, product development rollout schedule, and contract documents by engaging a “run” function that may be engaged by clicking on the “run” button 361 on model summary and run screen 360. After the user initiates construction of that model, modeling function 204 preferably presents the user with a status screen 370 (shown in FIG. 27) which provides a status bar 371 preferably indicating the status of completion of generating the complete model of the business development transaction.

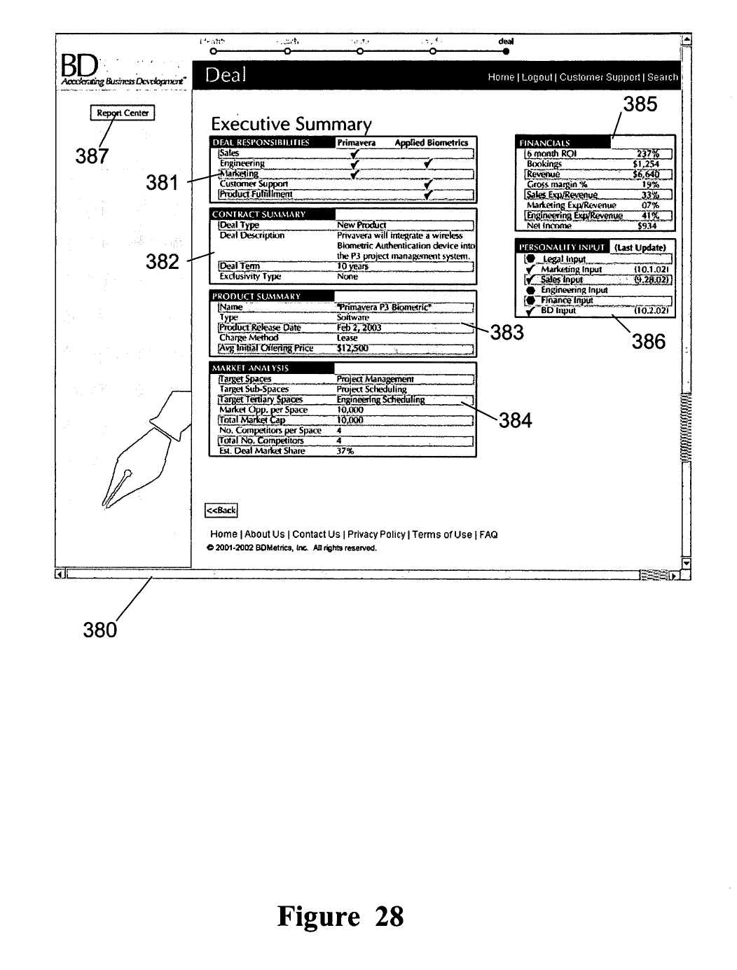

After the system has completed generating the complete model of the business development transaction in modeling step 204, the system automatically engages deal function 205. As shown in FIG. 28, when deal function 205 is engaged, it initially displays an executive summary of the business development transaction in an executive summary page 380, providing summary information preferably including: (i) deal responsibilities 381, which displays an indication of which of the parties to the business development transaction will have responsibility in the areas of sales, engineering, marketing, customer support, and product fulfillment; (ii) contract summary 382, which displays a summary of the business development transaction including the deal type, description, term, and whether or not the deal is exclusive; (iii) product summary 383, which displays a summary of the new product or service including the new product or service name, product or service type, release date, charge method, and price; (iv) market analysis 384, which displays a brief summary of the market opportunity for the new product or service including definition of the market space (including top level market space, sub-space, and tertiary space), the market opportunity per market space, the total market cap, the number of competitors in each space, the total number of competitors, and the estimated market share represented by the deal; (v) financials 385, which displays a summary of key financial figures pertaining to the business development transaction, including six month return on investment (stated as a percentage), bookings, revenue, gross margin (stated as a percentage), sales expenses and revenue (stated as a percentage), marketing expenses and revenue (stated as a percentage), engineering expenses and revenue (stated as a percentage), and net income; and (vi) personality input 386, which displays a list of all parties having specialized knowledge that are intended to contribute to the model during modeling function 204, and an indication for each of those parties of whether they have yet provided input to the model, and if so, the last date on which they provided such input.

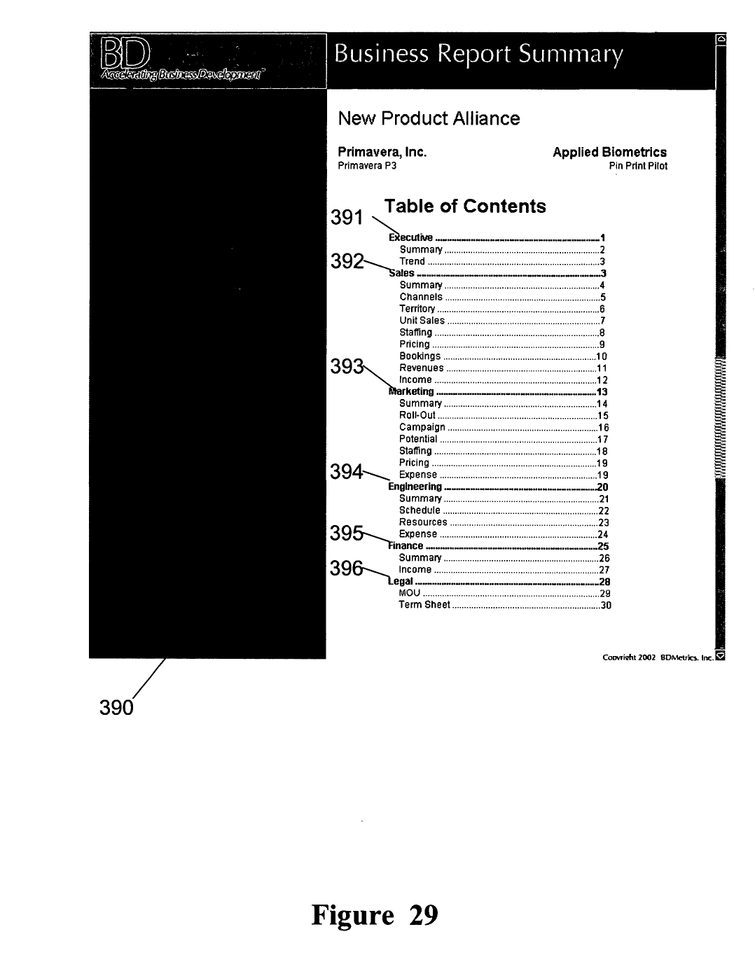

In addition to providing the overall summary of the business development transaction to the user, deal function 205 also enables the user to engage a report function by instructing the system to launch a report center by pressing the “report center” button 387 on executive summary screen 380. Engaging the report function causes the system to present the user with a business report detailing various facets of the business development transaction. As shown in FIG. 29, when the report function is engaged, a business report summary screen 390 is preferably generated which enables the user to view an executive reports section 391, and a report section devoted to each of the “personalities” from whom input concerning the business development transaction was solicited, namely, sales 392, marketing 393, engineering 394, finance 395, and legal 396.

Preferably, legal report section 396 includes both a draft memorandum of understanding and a draft term sheet, which have been generated from the data input by the user describing the particular deal type.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for evaluating a business development transaction, comprising the steps of:
prompting a user to create a business development file describing a product or service;
adding such business development file to a database containing a plurality of business development files;
searching said database to locate at least one business development file meeting a predefined compatibility threshold to warrant investigation of a business development transaction;
identifying at least one target business development file produced from said search for combinatory evaluation;
initiating a mating function between said created business development file and said target business development file;
initiating construction of a financial model of said business development transaction based on said mating function; and
creating human readable forms illustrating said financial model.

2. A system for evaluating a business development transaction, comprising a micro-processor controlled business development server system, said business development server system further comprising executable computer instructions to:
prompt a user to create a business development file describing a product or service;
add such business development file to a database containing a plurality of business development files;
search said database to locate at least one business development file meeting a predefined compatibility threshold to warrant investigation of a business development transaction;
identify at least one target business development file produced from said search for combinatory evaluation;
initiate a mating function between said created business development file and said target business development file;
initiate construction of a financial model of said business development transaction based on said mating function; and
create human readable forms illustrating said financial model.
